(19) United States
(12) Patent Application Publication
(10) Pub. No.: US 2024/0181587 A1
(43) Pub. Date: Jun. 6, 2024

(54) SYSTEMS, METHODS AND APPARATUS FOR CONTROL OF POSITIONING SYSTEMS

(71) Applicant: Shaper Tools, Inc., San Francisco, CA (US)

(72) Inventors: ILAN ELLISON MOYER, Chapel Hill, NC (US); ROBERT HEMSLEY, Bremen, ME (US); SAM CUTTRISS, Oakland, CA (US); DYLAN MILLER FAIRBANKS, Alameda, CA (US); RUNDONG TIAN, Albany, CA (US)

(73) Assignee: Shaper Tools, Inc., San Francisco, CA (US)

(21) Appl. No.: 18/553,554

(22) PCT Filed: Apr. 6, 2022
(86) PCT No.: PCT/US22/71584

§ 371 Date: Sep. 30, 2023

Related U.S. Application Data
(60) Provisional application No. 63/202,195, filed on May 31, 2021.
(60) Provisional application No. 63/200,997, filed on Apr. 7, 2021.

(51) Int. Cl. B23Q 15/007; B23Q 3/18

(52) U.S. Cl. CPC B23Q 15/0075; B23Q 3/18

(57) ABSTRACT

Systems and methods for controlling positioning systems with stage moving under the control of direct user input to provide a user with a seemingly transparent interaction experience. A user contacts a handle coupled to the stage to provide input to a controller to effectuate stage motion. User input may include force applied to a load cell coupled to the handle to indicate a desired direction or speed for motion of the stage. Position system controller may be configured to provide tactile feedback to the user communicating stage position and speed information.

### CROSS-REFERENCE TO RELATED APPLICATION

This application claims the benefit of priority to U.S. Provisional Patent Application No. 63/200,997, titled “Manual Control for Positioning System” and filed on Apr. 7, 2021, and U.S. Provisional Patent Application No. 63/202,195, titled “Control for Positioning System” and filed on May 31, 2021, both of which are incorporated by reference in their entirety herein for all purposes.

### BACKGROUND

### Field of the Disclosure

This disclosure relates to the field of control systems for controlling the motion of stage positioning systems.

### Description of Related Art

Stage control systems in the art include one- or multi-axis translation stage systems controlled by sensors included in keypads (e.g., D-type keypads, directional arrow keys, etc.), joysticks, jog dials, trackpads, and various input devices coupled with software interfaces on controlling computer systems. In most systems the sensor output is communicated to an actuator controller which then provides output to control an actuator to effectuate the motion of the stage. Such stage systems may include a stage travel range from 100 mm up to a few meters. Stage systems for wood working typically include stage travel range of 100s of millimeter to up to 1-3 meters.

For example, a joystick may be attached to an edge of a table on which an XY stage is mounted. The joystick input is mapped to effectuate the motion of the XY stage in the direction of the joystick displacement (from rest) with the speed of the XY stage mapped to the magnitude of the joystick displacement. In another example, a D-type keypad may be mounted directly on an XY stage mounted on a table. By selecting the appropriate directional key on the D-type keypad, a user can move the stage in the desired direction. In such instances, the D-type keypad moves with the stage; hence, the user moves her or his hand with the stage to provide input on the D-type keypad.

In another example, a rail mounted gantry crane may include a motorized cart mounted to a rail (e.g., permitting the cart to move along the rail; in the X direction) with the rail mounted to a track system to permit the rail to move in another direction (e.g., in the Y direction). The motorized cart may include a motor with a winch to control the motion of a lift hook (e.g., in the Z direction). In some cases, a wired remote connected to the motorized cart includes input buttons to effectuate the XY motion of the cart and the Z motion of the hook. In some instances, the wired remote is described as a pendant remote because it hangs down from the cart and moves with the cart.

In the above-described examples, a user interacting with the stage system, using the described control systems, does not get the experience of moving the stage which mimicks the motion of grabbing the stage or cart with their hands and moving it to a desired position, which may be possible, for example, if the user was backdriving the stage system with the stage actuators deenergized.

### SUMMARY OF THE DISCLOSURE

The embodiments described herein enable a user to control the motion of a stage (e.g., including any combinations of one or more translational degrees of freedom or one or more rotational degrees of freedom) based on an interaction with one or more sensors that allow the user to experience actuator-driven motion of the stage mimicking the experience of freely moving the stage. For example, the control system for the positioning system may tune the properties and dynamics of the positioning system to align with how the user wishes to perceive its properties and dynamics (e.g., permitting a user to move a 50 kg stage and perceiving it as if the user is moving a much smaller (e.g., 5 kg) stage, tuning the friction to allow the user to start and stop the stage more optimally, changing the drag to mirror a designed motion experience for the user). In some embodiments, the perceived inertia, perceived friction, and perceived drag experienced by the user may be configured to make the user's perception of moving the stage, as the stage is driven by one or more actuators, seem “transparent” so that the properties and dynamics of the real positioning system are replaced with a virtual experience. In some embodiments, the users are made to feel as if they are directly moving the stage themselves instead of the stage motion being assisted by the one or more actuators. In some embodiments, the control of displacement or speed of the stage may be based on the magnitude of the applied force.

In some embodiments, position-based tactile feedback (e.g., virtual grid (e.g., at 5 mm increments), magnetic grid (e.g., attractor well at 5 mm increments)) may be provided to the user controlling the positioning system by modulating the motion of the stage at positions where the haptic feedback needs to be provided. In some embodiments, velocity-based tactile feedback (e.g., vibrations) may be provided to the user controlling the positioning system by modulating the motion of the system based on speed or direction of the stage, e.g., if the user is moving the stage too quickly or is moving the stage in the direction of an exclusion area.

### BRIEF DESCRIPTION OF THE DRAWINGS

FIG. 1A illustrates an exemplary embodiment of a positioning system.

FIG. 1B illustrates another exemplary embodiment of a positioning system.

FIG. 2 shows a perspective view of a prototype positioning system with a one-dimensional linear stage utilizing a disclosed interaction control process.

FIG. 3 shows a bottom view of the prototype positioning system shown in FIG. 3.

FIG. 4 shows a schematic view of an exemplary positioning system utilizing a disclosed interaction control process.

FIG. 5 shows a structural view of an exemplary positioning system implementing a disclosed interaction control process.

FIG. 6 shows a schematic view of an exemplary control system implementing a disclosed interaction control process.

FIG. 7 shows a schematic view of an exemplary control algorithm implementing a disclosed interaction control process.

FIG. 8 shows a schematic view of a stage used in a positioning system.

FIG. 9 shows a schematic view of another exemplary embodiment of a positioning system utilizing a disclosed interaction control process.

FIG. 10 shows a schematic view of another exemplary embodiment of a positioning system utilizing a disclosed interaction control process.

FIG. 11 shows a schematic view of another exemplary embodiment of a positioning system utilizing a disclosed interaction control process

FIG. 12 shows a schematic view of an exemplary one-dimensional linear stage implementing a disclosed interaction control process.

FIG. 13 shows hypothetical force versus time data from a force sensor during the probing of a workpiece edge on an exemplary positioning system implementing a disclosed interaction control process.

FIG. 14 shows a hypothetical position versus time data for the example from FIG. 13.

FIG. 15 shows a hypothetical force versus position data for the example from FIGS. 13 and 14.

FIG. 16 shows a schematic view of information displayed by an exemplary positioning system during a cutting task.

FIG. 17 shows an exemplary process flow for an exemplary control system used with a positioning system.

FIG. 18 shows a illustrates an exemplary computer system that may execute code implementing a disclosed interaction control process.

### DETAILED DESCRIPTION

In some embodiments, the positioning system comprises a stage (e.g., with one or more translational or rotational degrees of freedom) capable of supporting a device. In some embodiments, the stage may control the motion of a device attached to the stage to effectuate a task performed by the device (e.g., the device may be a cutting spindle and the task may be cutting a path in a piece of wood). In some embodiments, the device may be a laser cutter (for performing a cut on a workpiece), a drawing tool (for drawing on a surface), an ink-jet head (for printing on a surface), a camera (for capturing images on a surface), or the like. In some of the embodiments described below, the device is referenced as a cutting spindle.

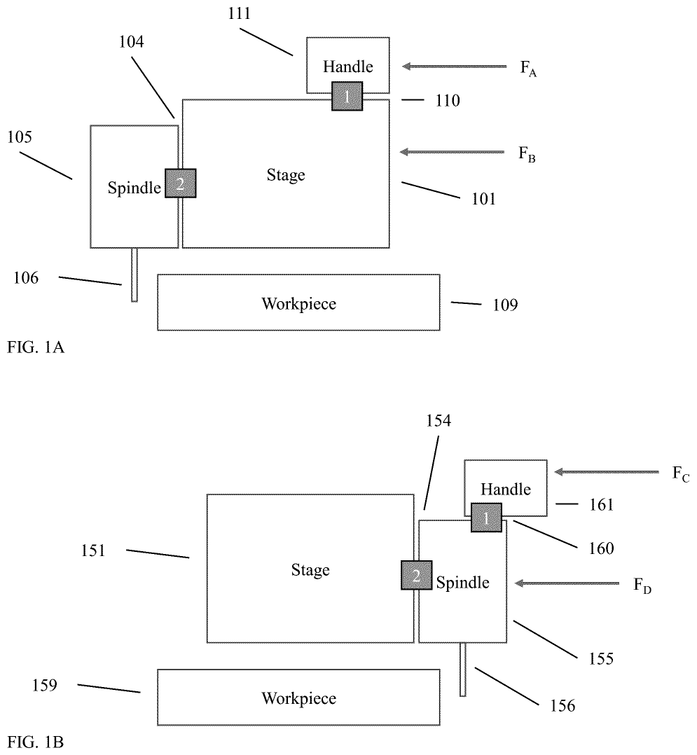

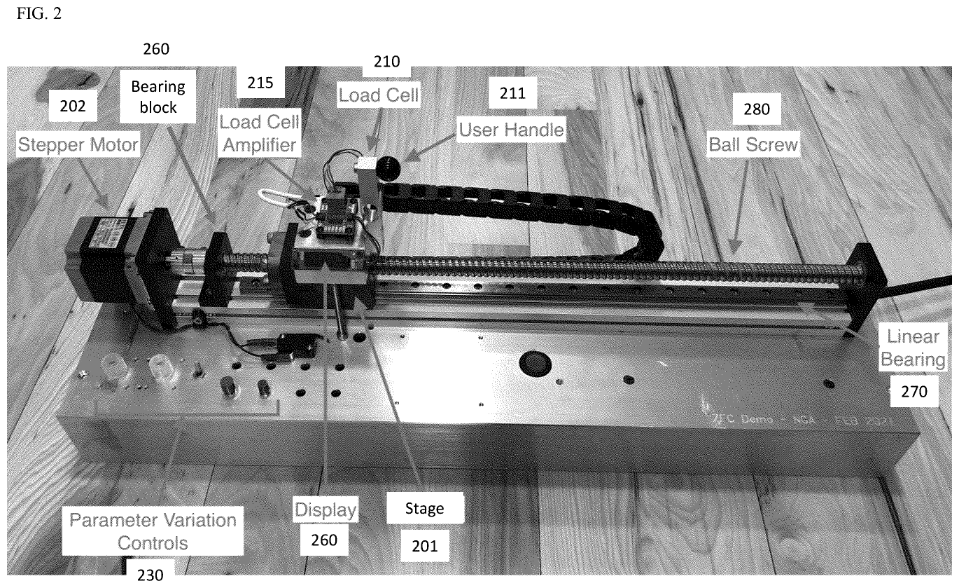

FIG. 1A illustrates an exemplary schematic view of a positioning system including a stage 101, a spindle 105, and a handle 111. The stage 101 is movable in the horizontal direction. The spindle 105 and the handle 111 are mounted to the stage. A first sensor (e.g., force sensor) 110 is located between the handle 111 and the stage 101. A second (optional) sensor (e.g., force sensor) 104 is located between the spindle 105 and the stage 101. A cutting bit 106 is mounted to the spindle 105 (e.g., using an adapter, holder, chuck, or the like). Workpiece 109 is shown below the positioning system. Note: Element numbers in figures are coordinated to make corresponding components easier to identify, e.g., handles: 111, 161, 211, 5111, 911, 1011, 1111, 1211.

In some embodiments, the stage 101 may be movable in the vertical direction or in a direction into or out of the illustrated plane. In some embodiments, the stage motion in the non-horizontal directions may be controlled by forces applied to the handle in the respective non-horizontal directions, for example, as described below for motion in the horizontal direction. In some embodiments, the stage motion in the non-horizontal directions may be restricted such that a force applied to the handle in a non-horizontal direction does not lead to motion of the stage in the non-horizontal direction of the applied force. In some such embodiments, the motion of the stage 101 in the non-horizontal direction(s) may be controlled by one or more other inputs from the user, e.g., using control keys, joystick, jog dial, or force sensor (fixed or partially fixed relative to a moving stage).

As described below, the positioning system controls actuators (not shown) to move the stage 101 based on signals detected by the first sensor 110. In response to a force (FA) applied to the handle by a user, the positioning system moves the stage 101, the spindle 105, and the handle 111 to the left by controlling actuators coupled to the stage 101. In some embodiments, if the user applies the same force directly to the side of the stage 101 (e.g., as shown by FB), the stage 101, spindle 105, and handle 111 do not move to the left because the first sensor 110 does not detect applied force FB. In this arrangement, static forces applied to the spindle 105 are not directly sensed by the first sensor 110, and static forces applied to the handle 111 are not directly sensed by the second sensor 104.

The second sensor 104 may measure static or dynamic forces. For example, the second sensor 104 may measure the weight of the spindle 105. The second sensor 104 may measure a signal based on the inertial mass of the spindle 105 as the stage 101 moves the spindle 105. The second sensor 104 may measure a signal based on a reaction force applied by the workpiece 109 to the cutting bit 106 if the stage 101 moves to the right to bring the cutting bit 106 in contact with the workpiece 109. Similarly, the first sensor 110 may measure similar static (e.g., weight of handle 111) or dynamic forces (e.g., based on the inertial mass of handle 111).

FIG. 1B illustrates an exemplary schematic view of another positioning system including a stage 151, a spindle 155, and a handle 161. The stage 151 is movable in the horizontal direction. The spindle 155 is mounted to the stage 151, and the handle 161 is mounted to the spindle 155. A first sensor (e.g., force sensor) 160 is located between the handle 161 and the spindle 155. A second sensor (e.g., force sensor) 154 is located between the spindle 155 and the stage 151. A cutting bit 156 is mounted to the spindle 155. Workpiece 159 is shown below the positioning system. Embodiments of positioning systems described herein may use the first sensor 160 alone, the second sensor 154 alone, or both sensors together.

The positioning system may control actuators (not shown) to move the stage 151 based on: (1) signals from only the first sensor 160, (2) signals from only the second sensor 154, or (3) a combination of the signals from the first sensor 160 and the signals detected by the second sensor 154. Depending on the control scheme adopted by the positioning system, the first sensor 160, the second sensor 154, or neither may be omitted.

In response to a force (F_{c}) applied to the handle by a user, the positioning system moves the stage 151, the spindle 155, and the handle 161 to the left by controlling actuators coupled to the stage 151. In some embodiments, if the user applies the same force directly to the side of the stage 151 (as shown by FD) and if the positioning system controls actuators to move the stage 151 based on only the signals detected by the first sensor 160 (not based on the signals detected by the second sensor 154), the stage 151, spindle 155, and handle 161 do not move to the left because the first sensor 160 does not detect applied force FD. In this arrangement, static forces applied directly on the spindle 155 are not directly sensed by the first sensor 160; however, static forces applied to the handle 161 are directly sensed by the second sensor 154. The first sensor 160 may measure static (e.g., weight of handle 161) or dynamic forces (e.g., from inertial mass of handle 161). The second sensor 154 may measure static (e.g., weight of spindle 155, handle 161) or dynamic forces (e.g., from inertial mass of spindle 155, handle 161).

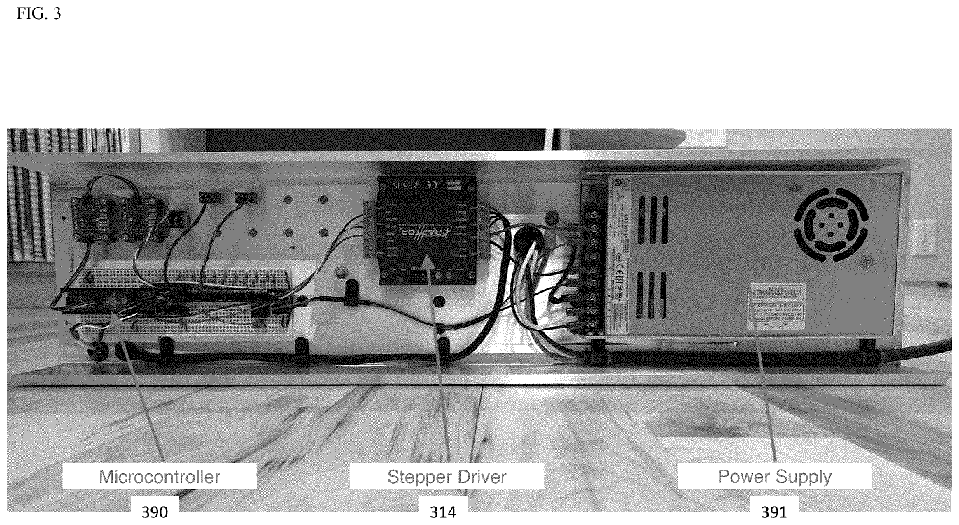

FIG. 2 shows a perspective view of another exemplary positioning system. The positioning system includes a stage 201 coupled to a ball screw 280 and mounted on a linear bearing 270. A stepper motor 202 rotates the ball screw 280 to effectuate motion of stage 201. In some embodiments (e.g., see FIG. 11), a bearing block 260 is coupled to the ball screw 280, and a (force or torque) sensor associated with a bearing block 260 (e.g., in the bearing block mount) may be used to determine forces exerted by the ball screw 280 on the moving components (e.g., stage, spindle (not shown)) by measuring reaction forces. A first end of load cell 210 is coupled to the stage 201, and a handle 211 (spherical knob) is coupled to the other end of the load cell 210. A load cell amplifier 215 measures the output of the load cell 210.

FIG. 3 shows a bottom view of the positioning system shown in FIG. 2. A microcontroller 390 receives inputs from the load cell amplifier 215 and the parameter variation controls 230. The microcontroller 390 sends outputs to the display 260 and the stepper driver 314. The stepper driver 314 drives the stepper motor 202. The power supply 391 provides power for the positioning system.

As described below, the load cell 210 detects a user-applied force on the handle 211, and the microcontroller 390 uses the output of the load cell 210 (from load cell amplifier 215) to drive the stepper motor 202 to move the stage 201. For example, if a user applies a force on the handle 211 in the direction of the stepper motor 202, the stepper motor 202 rotates the ball screw 280 to move the stage 201 towards the stepper motor 202. Similarly, if a user applies a force on the handle 211 in a direction away from the stepper motor 202, the stepper motor 202 rotates the ball screw 280 to move the stage 201 away from the stepper motor 202. In some embodiments, the control system attempts to “zero-out” the user's force input on handle 211 by moving the stage 201 (and handle 211) away from the user's touch—allowing the handle 211 to “escape” from the user touch and reduce the force applied by the user on the handle.

In some embodiments, the control system makes the motion of the stage 201 seem “transparent”—a user gets the sense that they are moving the stage 201 directly with little or no input or assistance being provided by the stepper motor 202 as long as they are “moving” the stage 201 using the handle 211. However, if the user applies a force directly on the stage (not on handle 211 but, for example, near the ball screw 280), the stage would not move if the stepper motor 202 is still energized. In some embodiments, the load cell 210 is designed to have a stiffness such that a force input of 10 N displaces the free end of the load cell less than 5 mm, 2 mm, 1 mm, 0.5 mm, 0.2 mm, 0.1 mm, 0.05 mm, 0.02 mm, 0.01 mm, 0.005 mm, 0.002 mm, or 0.001 mm relative to the fixed end of the load cell. The small displacement of the free end of the load cell reinforces the transparency sensed by the user controlling the stage; the user senses that they are directly causing the motion based on their input. In some embodiments, other sensors (e.g., sensor between spindle and stage as described above) providing feedback to the control system are also stiff (i.e., low strain/deflection under applied stress/force)—high stiffness of the sensors allows the positioning system to: (1) achieve positional accuracy, (2) control vibrations, or (3) avoid task performance issues (e.g., if the stage system is not sufficiently stiff, cutter on a spindle can grab the material being cut and lead to chatter).

In some embodiments, the user interacts with the positioning system by pushing, pulling, or rotating a feature (e.g., handle) coupled to a stage to provide input—this natural interaction between the user and the positioning system to cause motion of the stage helps the user transparently control the positioning system. The user's ability to reverse the direction of the stage's motion by reversing the user's input (from a pulling motion to a pushing motion or vice versa) further reinforces the user's experience of directly causing the motion of the stage controlled by the positioning system.

In some embodiments, the microcontroller 390 may implement a control loop based on a velocity gain model; a force detected on the handle 211 is converted to a stage velocity using a gain of, for example, 1 mm/s/N. In this example, if the user applies 1 N on the handle 211 towards the stepper motor 202 (“pushes or pulls with a force equal to 1 N”), the microcontroller 390 transitions to instructing the stepper motor 202 to move the stage 201 at 1 mm/s towards the stepper motor 202. If the user wishes to slow down the motion of the stage, they can reduce the input force to 0.5 N on the handle towards the stepper motor 202 (“pushes or pulls with a force equal to 0.5 N”), and the microcontroller 390 transitions to instructing the stepper motor 202 to move the stage 201 at 0.5 mm/s towards the stepper motor 202. If the user wants to reverse the direction of the moving stage, the user may apply 2 N of force on the handle 211 away from the stepper motor 202 (“pulls or pushes with a force equal to 2 N”), the microcontroller 390 transitions to instructing the stepper motor 202 to move the stage 201 at 2 mm/s away from the stepper motor 202. Under this velocity gain model, the user moves the stage 201 at a velocity in proportion to the force input on the handle 211. In some embodiments, the gain may range from 0.25 to 40 mm/s/N. In some embodiments, the gain may be user adjustable in two or more modes to allow the user to configure the positioning system for different types of movements of the stage, e.g., two modes with gain between 0.25-2 mm/s/N for fine stage movements and gain between 5-40 mm/s/N for coarse stage movements. As described below, the microcontroller 390 may sample the load cell 210 at a high rate (e.g., 500 Hz) to give seeming immediate response to changes in the user's input—further reinforcing the transparency sensed by the user controlling the stage.

In some embodiments, the microcontroller 390 may control the motion of the stage 201 based on the user's input force on the handle 211 combined with one or more of virtual inertia, virtual friction, virtual drag, and haptic feedback (e.g., virtual grid lines, detents, attractors, and detractors) based on simulated physics models as described below. Parameters related to virtual inertia, virtual friction, virtual drag, or haptic feedback may be selected for viewing on display 260 and entered using the parameter variation controls 230.

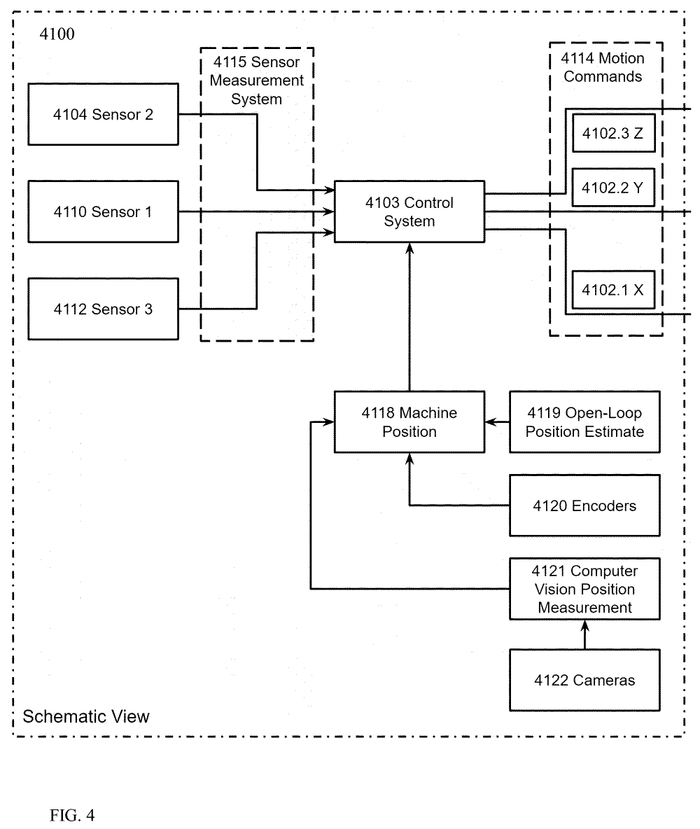

FIG. 4 shows a schematic view of an exemplary positioning system 4100 including sensors 4104, 4110, and 4112 and sensor measurement system 4115 to measure the output from the sensors 4104, 4110, and 4112. One or more of the sensors 4104, 4110, or 4112 may be a force sensor, torque sensor, touch sensor, capacitive sensor, or the like. A control system 4103 receives the output of the sensor measurement system 4115. The control system 4103 also receives machine position information 4118. The machine position information may be based on one or more of open-loop position data 4119, encoder data 4120, CV-based position data 4121 (CV: location based on imaging features and comparing to pre-existing map image, computer vision using SLAM, etc.), or the like, e.g., for the stage. The CV-based position data 4121 may be based on images captured using one or more cameras 4122. The control system 4103 provides motion commands 4114 to one or more actuators 4102.1 X, 4102.2 Y, and 4102.3 Z. Each actuator may be a motor, a stepper motor, a linear motor, a pneumatic actuator, hydraulic actuator, or the like.

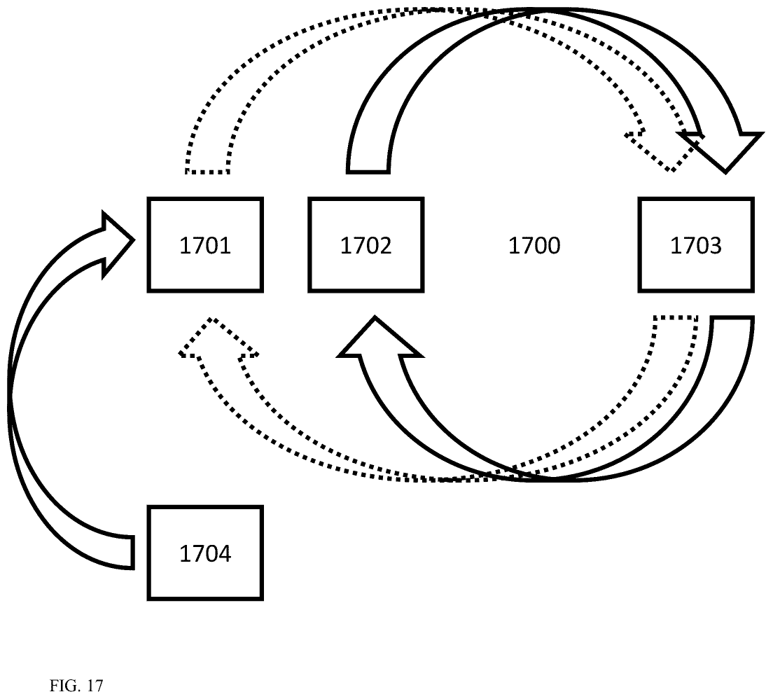

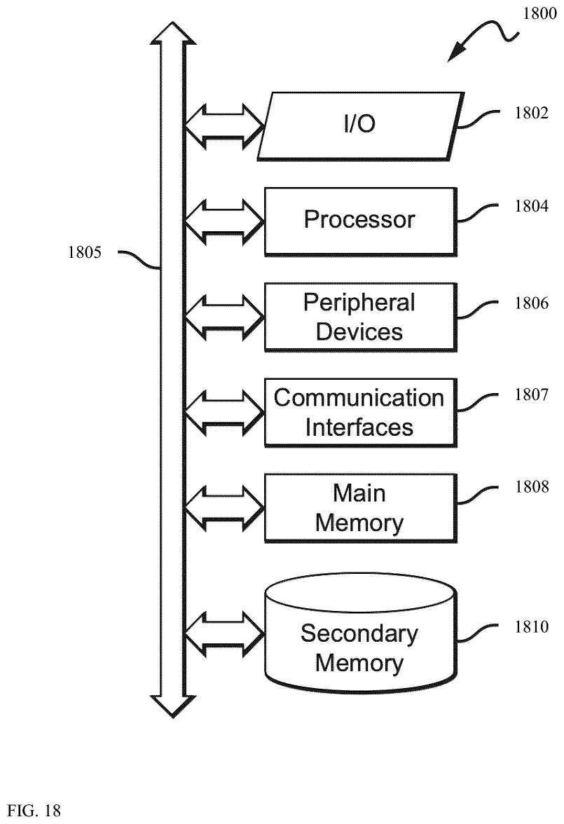

FIG. 17 schematically illustrates an exemplary control loop 1700 implemented by a control system (e.g., control system 4103). Sensor data 1701 (e.g., from force sensors) and position data 1702 (e.g., for position-based haptic effects, virtual grid) are used to determine motion commands 1703. The motion commands 1703 result in changes to the sensor data 1701 (e.g., force sensor “escapes” user's touch) or position data 1702 (e.g., stage moves in response to the motion commands 1703). The updated sensor data 1701 or position data 1702 are used to determine updated motion commands 1703 as illustrated in the schematic loop 1700. User input 1704 (e.g., on handle) may also effectuate a change to sensor data 1701 depending on the user's intent. In some embodiments, a control system (e.g., control system 4103) iterates the collection of sensor data and position data and providing motion commands (e.g., collect sensor data, collect position data, provide motion commands; repeat) at 10 Hz, 20 Hz, 50 Hz, 100 Hz, 200 Hz, 500 Hz, 1000 Hz, 2000 Hz, or more. In some embodiments, the sensor may be sampled at 10 Hz, 20 Hz, 50 Hz, 100 Hz, 200 Hz, 500 Hz, or more. In some embodiments, the control system loop iteration frequency may be higher than the frequency at which the sensor is sampled. In some embodiments, this helps resolve contact events more accurately (e.g., if using a comparator to compare contact force to a contact force threshold).

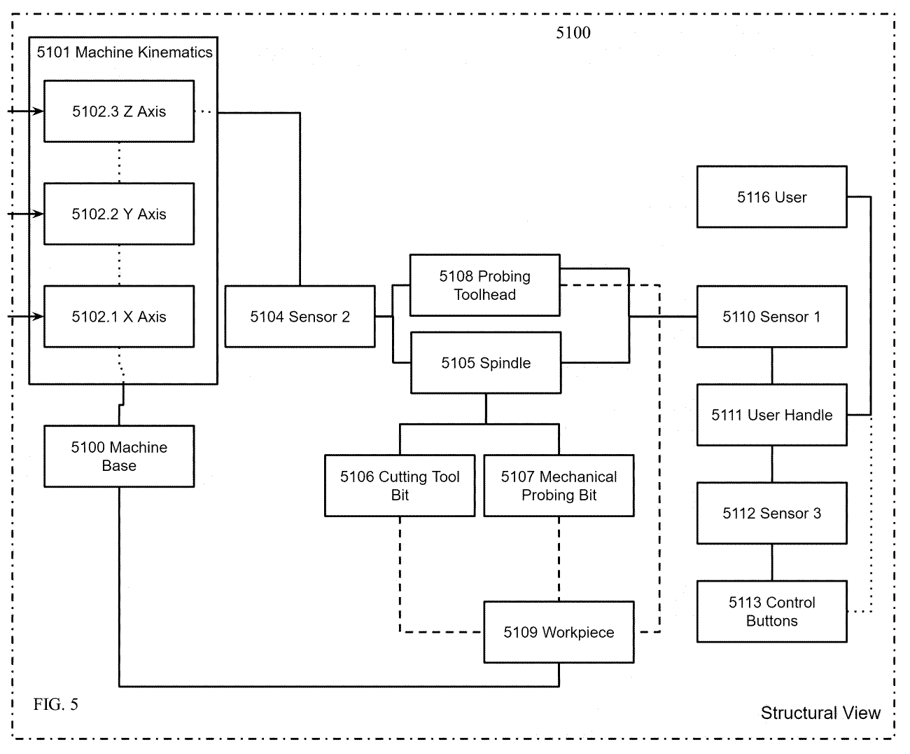

FIG. 5 illustrates a structural view of an exemplary positioning system 5100. Positioning system 5100 includes machine kinematics 5101 including one or more axes 5102.1 X, 5102.2 Y, 5102.3 Z. The machine kinematics 5101 are coupled to a spindle 5105. A handle 5111 is coupled to the spindle 5105. In some embodiments, a first sensor 5110 is located between the handle 5111 and the spindle 5105. In some embodiments, a second sensor 5104 is located between the spindle 5105 and the machine kinematics 5101. In some embodiments, input devices (e.g., control buttons, etc.) 5113 are coupled to the handle 5111. In some embodiments, a third sensor 5112 is located between the input devices 5113 and the handle 5111. The output from the third sensor 5112 may be used to avoid having activity associated with the input devices 5113 trigger motion of the positioning system (e.g., if the activity is also detected by the first sensor 5110 or the second sensor 5104). The spindle 5105 may have a cutting bit 5106 or mechanical probing bit 5107 installed in an adapter/holder/chuck (not shown). The positioning system 5100 may be used to complete a task (e.g., cut a path, drill holes, draw, paint, probe height, probe shape) on or associated with a workpiece 5109. In some embodiments, a probing toolhead 5108 may be attached to the machine kinematics 5101 instead of the spindle 5105. The probing toolhead 5108 may be used to probe properties of the workpiece 5109. In some embodiments, a mechanical probing bit 5107 may be mounted in the spindle 5105 (instead of the cutting tool bit 5106); the mechanical probing bit 5107 may be used to probe the workpiece 5109 (e.g., instead of using the cutting tool bit 5106 to probe the workpiece). The probing toolhead 5108 or the mechanical probing bit 5107 may have one or more integrated sensors to probe the workpiece edge (to determine shape, position, etc.), top surface/topography, thickness, etc.—see, for example, probe and probe holders from Renishaw (https://www.renishaw.com/n/machine-tool-probes-and-software-6073).

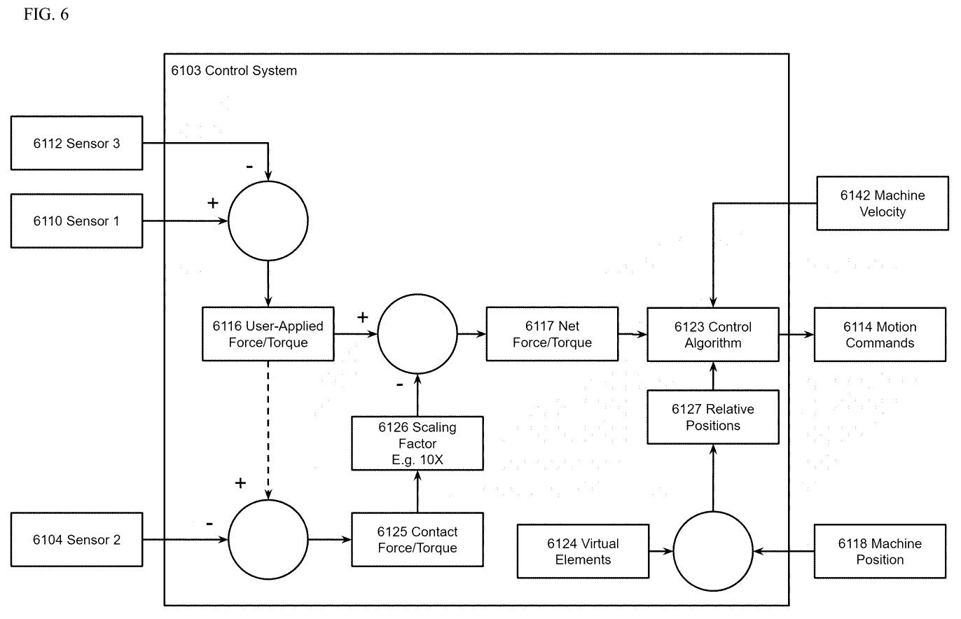

FIG. 6 illustrates a schematic for an exemplary control system 6103 for an exemplary positioning system. Control system 6103 receives inputs from a first sensor 6110 (e.g., from a handle), a second sensor 6104 (e.g., from a spindle), and a third sensor 6112 (e.g., from input devices). In some embodiments, the control system 6103 determines a user-applied force 6116 based on one or more of the first, second, and third sensor inputs. In some embodiments, control system 6103 determines a contact force 6125 based on one or more of the first, second, and third sensor inputs. In some embodiments, control system 6103 scales the contact force 6125 using a scaling factor 6126 (e.g., to tune contact detection sensitivity). The control system 6103 determines a net force 6117 based on the user-applied force 6116, the contact force 6125, and the scaling factor 6126.

The control system 6103 includes a control algorithm 6123 which receives the net force 6117 as an input. Machine positions 6118 and virtual element data 6124 (e.g., related to position-based tactile force) are together referred to as position data 6127. In some embodiments, the control algorithm 6123 receives the machine positions 6118 and the virtual element data 6124. In some embodiments, the control algorithm 6123 receives machine velocity information 6142 (e.g., from motion controllers, encoders, CV data). In some embodiments, the machine positions 6118 are determined based on machine velocity information 6142 (e.g., by integrating the velocity data). In some embodiments, the control algorithm 6123 receives machine positions (e.g., from motion controllers, encoders, CV data). In some embodiments, the machine velocity information 6142 is determined based on machine positions 6118 (e.g., by determining a rate of change of the position data). The control algorithm 6123 outputs the motion commands 6114 to the motion controllers/actuators. The control system 6103 illustrated in FIG. 6 relates to a particular arrangement of the sensors (e.g., similar to the arrangement shown in FIG. 1B). In other embodiments, the control system schematic may vary depending on the arrangement of the sensors (e.g., 6104 may be used to detect the user-applied force and contact forces on the spindle with sensor 6110 and sensor 6112 being omitted).

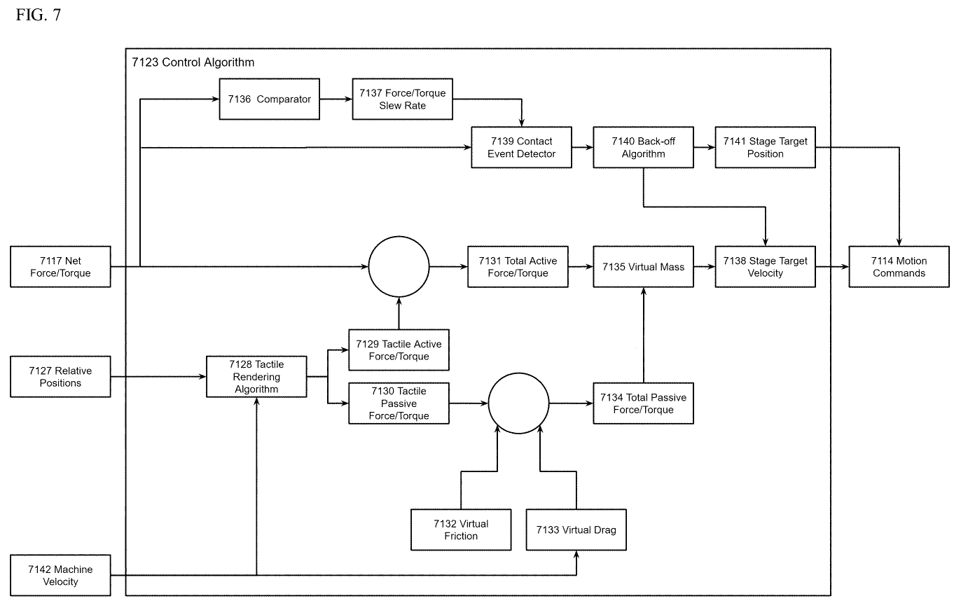

FIG. 7 illustrates a schematic for an exemplary control algorithm 7123 for an exemplary positioning system. The control algorithm 7123 receives net force 7117, position data 7127, and machine velocity information 7142. In some embodiments, the control algorithm 7123 uses the position data 7127 and machine velocity information 7142 along with a tactile rendering algorithm 7128 to determine tactile active force 7129 (e.g., attractor-type haptic feedback) and tactile passive force 7130 (e.g., wall-type haptic feedback). The tactile rendering algorithm 7128 enables the positioning system to provide tactile feedback to the user. The control algorithm uses the net force 7117 and the tactile active force 7129 to determine the total active force 7131. In some embodiments, the machine velocity information 7142 is used to determine virtual drag 7133. The tactile passive force 7130, virtual friction 7132, and virtual drag 7133 are used to determine total passive force 7134. In some embodiments, the total active force 7131, virtual mass 7135, and total passive force 7134 are used to determine target velocity data 7138 (e.g., using a dynamic model of the system). The target velocity data 7138 is used to determine motion commands 7114.

In some implementations, the dynamic model may include aspects related to the simulated physics of the virtual stage motion experienced by the user (masking the properties and dynamics of the real stage). The dynamic model may include inertia by which acceleration of a mass is related to applied force. The dynamic model may include static friction under which motion does not occur until applied force exceeds the static friction. The dynamic model may include dynamic friction which corresponds to an offset subtracted from the applied force when calculating the resulting motion. In some embodiments, the control algorithm may subtract calculated real inertial forces (e.g., from the mass of the spindle or handle accelerating) from measured forces to determine applied forces.

In some embodiments, tactile feedback may be provided based on one or more of: (1) virtual grid lines at programmable increments, (2) virtual contact with an overlaid feature in the work space (stage motion space; e.g., digital design or cutting path), (3) virtual contact with snap points in the work space or on a digital design (e.g., the center of a circle), or (4) proximity to the work surface or workpiece, in X, Y, and Z (e.g., clamps in the work space, edge of work space, edge of workpiece). The tactile feedback may be implemented as one or more of: (1) detents, requiring increased force to overcome, (2) attractors (e.g., a negative spring within a certain proximity, either using a proportional or non-linear spring constant), or (3) detractors (e.g., a positive spring within a certain proximity, either using a proportional or non-linear spring constant).

In some embodiments, the control algorithm 7123 uses the net force 7117 to detect a contact event 7139. In some embodiments, the contact event 7139 is detected based on a change of the net force 7117 (e.g., via comparator 7136; for example, comparing the net force to a threshold value) or a rate of change of the net force 7117 (e.g., via force slew rate 7137). In some embodiments, if a contact event is detected, the control algorithm 7123 may back-off the stage using a back-off algorithm 7140 with the back-off algorithm providing target position data 7141 or target velocity data 7138 to determine motion commands 7114.

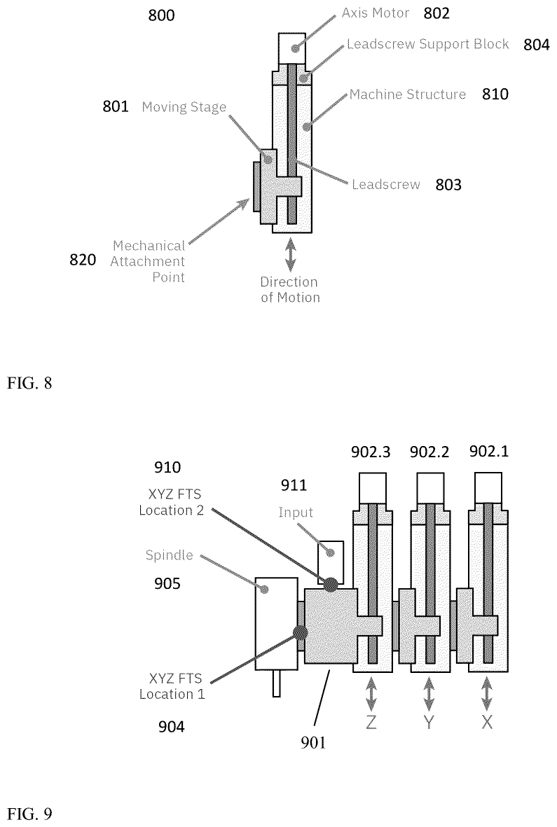

FIG. 8 illustrates a schematic view of an exemplary one-dimensional stage unit 800 with stage 801 having an attachment point 820. The stage is coupled to a lead screw 803, and the lead screw 803 is coupled to motor 802 and a support block 804. The stage unit 800 includes a base structure 810.

FIG. 9 illustrates a schematic view of an exemplary 3-axes positioning system with stage units 902.1 (X), 902.2 (Y), and 902.3 (Z). Handle 911 is coupled to stage 901. Spindle 905 is coupled to stage 901. First sensor 910 is located between the handle 911 and the stage 901. Second sensor 904 is located between spindle 905 and stage 901.

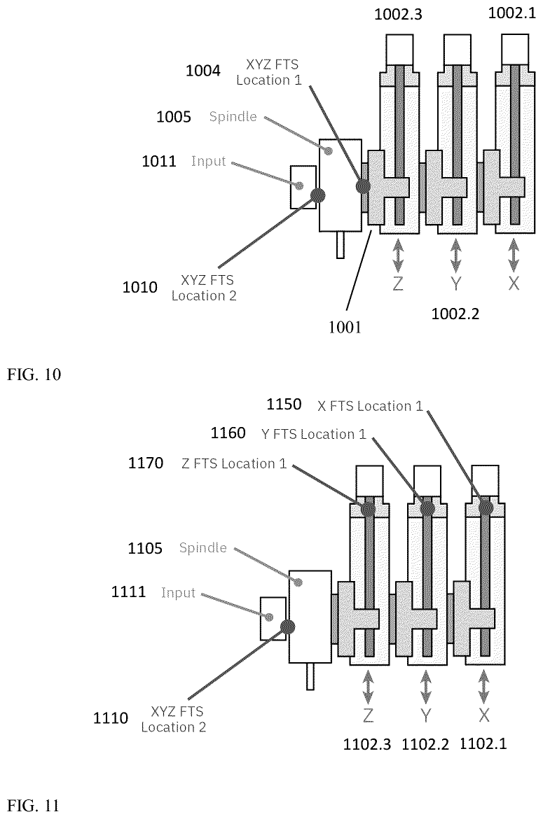

FIG. 10 illustrates a schematic view of an exemplary 3-axes positioning system with stage units 1002.1 (X), 1002.2 (Y), and 1002.3 (Z). Handle 1011 is coupled to the spindle 1005. The spindle 1005 is coupled to the stage 1001. First sensor 1010 is located between the handle 1011 and the spindle 1005. Second sensor 1004 is located between the spindle 1005 and the stage 1001.

FIG. 11 illustrates a schematic view of an exemplary 3-axes positioning system with stage units 1102.1 (X), 1102.2 (Y), and 1102.3 (Z). Handle 1111 is coupled with the spindle 1105. First sensor 1110 is located between the handle 1111 and spindle 1105. Sensors 1150, 1160, and 1170 measure forces or torques associated with stage units 1102.1 (X), 1102.2 (Y), and 1102.3 (Z), respectively. In this embodiment, if spindle 1105 contacts a workpiece while traveling in the X direction, sensor 1150 senses a force or a torque associated with additional resistance related to motion in the X direction.

Any of sensors 1150, 1160, or 1170 may be implemented as force or torque transducers situated between a linear transmission element (e.g., a lead screw) of a motion axis and the location where the axial (i.e. in-line with the actuated motion) constraint of that element is grounded to the base structure. This location may for example be between the axial support bearings of the linear transmission element and the base structure, and the force or torque transducers may be integrated into the bearing support block or may be externally attached to said block.

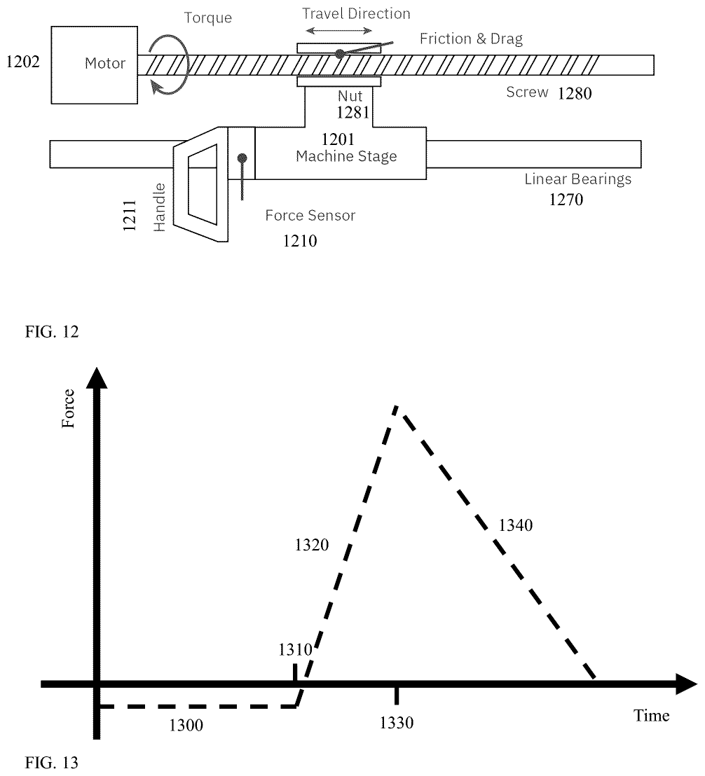

FIG. 12 illustrates a schematic view of an exemplary one-dimensional positioning system with stage 1201 coupled to a screw 1280 via nut 1281. The screw is coupled to a motor 1202. Handle 1211 is coupled to stage 1201 with force sensor 1210 between the handle 1211 and stage 1201. In some embodiments, stage 1201 may be backdrivable and a user may be able to cause the stage to move in either direction by applying a force to handle 1211. In some embodiments, a controller may control the motor to provide torque to compensate for or offset: (1) (static or dynamic) friction between the nut 1281 and screw 1280 or (2) drag forces on the stage 1201 while it is in motion. In some embodiments, the controller may characterize the system to measure components of (static or dynamic) friction or drag. Providing assistance using motor 1202 allows the positioning system to make the motion of the stage appear more “transparent” for the user.

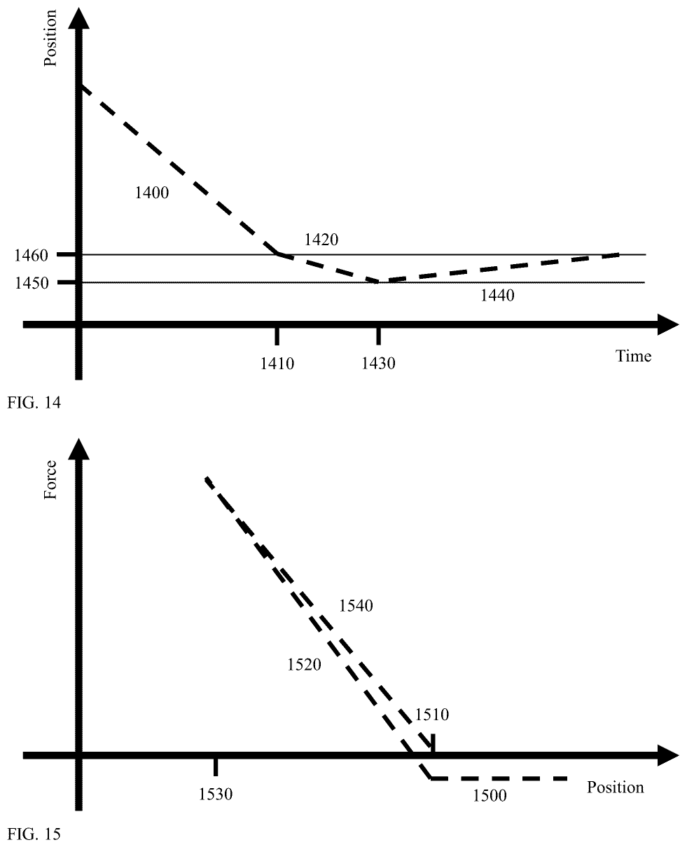

FIG. 13 shows a force versus time plot for an exemplary positioning system during a time period during which a stage component makes contact with an edge of a workpiece (see, for example, FIG. 1B). Note that the time axis is magnified to show contact event details—time scale may be 20 ms, 10 ms, 5 ms, 2 ms, 1 ms, or less. In the time period marked 1300, a user applies a negative force (e.g., measured by sensor 154) to drive the stage in the negative direction (left in FIG. 1B). At time 1310, the cutting bit (e.g., cutting bit 156 in FIG. 1B) contacts the edge of the workpiece (e.g., workpiece 159 in FIG. 1B). In response to the contact, the force increases rapidly over time period 1320—as the stage drives the cutting bit into the workpiece with the workpiece, cutting bit, spindle, or stage structure deforming (e.g., elastically) as a result. In response to the detected contact, starting at time 1330 and continuing over time period 1340, control system 4103 drives the stage back away from the workpiece (e.g., using back-off algorithm 7140, moving the stage in the positive direction) until the net force sensed by the sensor is zero. Control system 4103 may detect contact based on one or more of a slew rate of the force (e.g., 1000 N/s) or force threshold (e.g., threshold at 20 N if user typically exerts less than 10 N to move stage). In some embodiments, control system 4103 may back-off to create a gap between the cutting bit and the workpiece and then approach the workpiece at a lower speed to detect the contacting event (and corresponding contact position, see FIGS. 14, 15, below) more accurately. In some embodiments, for improved accuracy, the control system 4103 may probe a location near the point of initial contact in case the point of initial contact has deformed due to the first contact.

FIG. 14 shows a position versus time plot for the contacting event illustrated in FIG. 13. Note that the position and time axes are magnified to show contact event details—time scale may be 20 ms, 10 ms, 5 ms, 2 ms, 1 ms, or less, position scale may be 2 mm, 1 mm, 0.5 mm, 0.2 mm, 0.1 mm, or less. In the time period marked 1400, the stage is moving in the negative direction (left in FIG. 1B). At time 1410, the cutting bit contacts the edge of the workpiece with contact made at position 1460. Over time period 1420, the cutting bit is driven into the workpiece to position 1450. In response to the detected contact, starting at time 1430 and continuing over time period 1440, control system 4103 drives the stage back away from the workpiece back towards position 1460.

FIG. 15 shows a force versus position plot for the contacting event illustrated in FIGS. 13 and 14. Note that the position axis is magnified to show contact event details—position scale may be 2 mm, 1 mm, 0.5 mm, 0.2 mm, 0.1 mm, or less. In the position range marked 1500, the user applies a negative force to drive the stage in the negative direction. At position 1510 (corresponding to position 1460 in FIG. 14), the cutting bit contacts the workpiece. In the position range marked 1520, the cutting bit is driven into the workpiece to position 1530 (corresponding to position 1450 in FIG. 14). In response to the detected contact, over the position range marked 1540, control system 4103 drives the stage back away from the workpiece back towards position 1510. Assuming there is no change in the stiffness of the workpiece, the slope of lines 1520 and 1540 should be the same. FIG. 15 shows the lines displaced relative to each other for ease of visualization of the contact process. In some embodiments, the trajectory for force versus position during the contact phase may not be linear.

In some embodiments, referring back to the configuration described in FIG. 1B and assuming an exemplary positioning system is using a stage velocity gain of 1 mm/s/N based on the net force, if the user applies a force of 1 N on the handle 161 towards the stage 151 (in the direction of force F_{c}) before a cutting bit 156 (with spindle 155 turned off) contacts workpiece 159, the net force detected by the second sensor 154 is 1 N to the left (as depicted in FIG. 1B), and the positioning system sets the stage velocity to 1 mm/s to the left. Just after the cutting bit 156 makes contact with the workpiece 159, the workpiece applies a contact force of 1 N (directed to the right) on the cutting bit 156. At this point, the net force detected by the second sensor 154 is zero, and the positioning system brings the stage velocity to zero. The user senses that the contact has been made between the cutting bit 156 and the workpiece 159 based on the stage 151 stopping despite the application of a force of 1 N to the left by the user. Assuming that the system compliance is such that the workpiece 159 applies a force of 10 N/mm after the cutting bit 156 contacts the workpiece 159, the cutting bit penetrates the workpiece 159 by 0.1 mm after the point of contact. After the contact described above, if the user increases the applied force to 2 N to the left, the cutting bit penetrates the workpiece 159 by an additional 0.1 mm (total of 0.2 mm) relative to the point of contact, and the stage 151 again stops moving.

In some embodiments, if both the first sensor 160 and second sensor 154 are used in the control loop by the positioning system, the contact force and the user applied force may be determined separately. In the scenario in which the user is applying a force of 1 N to the left on handle 161 and the workpiece 159 is applying a contact force of 1 N to the right on the cutting bit 156 (after contact), the first sensor 160 measures a force of 1 N to the left, and the second sensor 154 measures a force of zero. The difference in the force measured by the first and second sensors indicates that the contact force is 1 N to the right. If a contact force scaling factor (e.g., scaling factor 6126) is set to 10 (instead of 1), the cutting bit 156 penetrates the workpiece by 0.01 mm after the point of contact (instead of penetrating the workpiece by 0.1 mm as described above). With the system compliance of 10 N/mm, the penetration of the cutting bit 156 into the workpiece 159 by 0.01 mm results in a contact force of 0.1 N to the right. This contact force is amplified by a factor of 10 based on the scaling factor to yield a scaled contact force of 1 N to the right. This scaled contact force of 1 N to the right offsets the user applied force of 1 N to the left on handle 161, and the resulting net force is zero (and the positioning system sets the stage velocity to zero). The contact force scaling factor may used during probing to improve the accuracy of detected point of contact (e.g., detecting point of contact within 0.01 mm instead of 0.1 mm).

Referring back to the above example, assume that the spindle 155 is turned on (with the cutting bit 156 spinning) and that the cutting forces on the cutting bit 156 may be modeled as providing a resistance of 1 N/(mm/s) based on the speed of the cutting bit 156 through the workpiece 159. If the user is applying a force of 1 N to the left on handle 161 before the cutting bit 156 encounters the workpiece 159, the positioning system sets the stage velocity to 1 mm/s to the left (based on a stage velocity gain of 1 mm/s/N and net force of 1 N to the left on the second sensor 154). After the cutting bit 156 enters the workpiece 159, the positioning system sets the stage velocity to 0.5 mm/s to the left. This is based on a net force of 0.5 N to the left on the second sensor 154 (1 N to the left applied by the user on handle 161 offset by 0.5 N to the right based on the cutting force). This allows the user to perceive the start of cutting based on a reduction of the speed of the stage 151 despite applying the same force of 1 N on the handle 161. If the user increases the applied force on handle 161 to 2 N to the left, the positioning system sets the stage velocity again to 1 mm/s to the left—2 N to the left applied by the user on handle 161 offset by 1 N to the right based on the cutting force, yielding a net force of 1 N to the left on the second sensor 154.

In some embodiments, a force measured inside a structural loop (e.g., user, stage, ground loop) or a portion of a structural loop is used to drive the motion of the stage (and, in turn, the device mounted to the stage). The placement of a sensor determines which forces are detected in the sensor's force measurement loop. For example, in the arrangement shown in FIG. 1B, sensor 154 is sensitive to forces applied to the handle 161 and the cutting bit 156. A sensor positioned close to ground (e.g., sensor 1150, 1160, or 1170 in FIG. 11) is sensitive to any upstream forces-a sensor associated with a bearing block is sensitive to most contact forces on the stage structure in its direction(s) of sensitivity. In some embodiments, the force sensor may be a one-, two-, or three-axis sensor—see, for example, multi-axis force sensor FNZ from Forsentek (http://www.forsentek.com/prodetail_279html). In some embodiments, the force sensor measures forces in linearly independent (e.g., orthogonal) directions (e.g., within an XY plane of motion). In some embodiments, the force sensor measures a force in a Z direction—permitting vertical motion of the stage (e.g., to engage or retract the cutting bit relative to a workpiece). In some embodiments, a force sensor may be mounted between the device and the stage to measure forces on the device as tasks are performed by the device. In some embodiments, the force sensor is a strain gauge, piezoelectric force sensor, capacitive force sensor, Hall effect sensor, inductive distance sensing, or the like.

In some embodiments, a force sensor, a torque sensor, pressure sensor, touch sensor, a joystick, or the like may be used to detect the input from the user. In some embodiments, sensor selection is based on requirements related to measuring force or torque with highest possible sensitivity and lowest noise, while (depending on implementation) introducing minimal additional mechanical compliance (e.g., maintain user transparency experience, maintain stage positioning accuracy, minimize vibrations). In some embodiments, instead of a force sensor, motor drive parameters (e.g., drive current indicating motor torque) may be used to infer the force experienced by the stage along the motor-drive-axis. In some embodiments, instead of a force sensor, the motor torque may be estimated based on the phase-angle relationship between the electrical position of the stator and the mechanical position of the rotor, and the estimated torque may be used to infer the force experienced by the stage along the motor-drive-axis.

In some embodiments, the positioning system may utilize a belt-driven configuration to move the stage. In some embodiments, the belt-driven configuration may include two or more pulleys with a belt forming a continuous or nearly continuous loop between the pulleys. The belt-driven configuration includes a driven pulley mounted to a motor, while other pulleys may be free-spinning idler pulleys. A moving stage may be attached at some point in the continuous loop of the belt, while the pulleys are grounded to a frame. In another embodiment, the belt-driven configuration may include a single belt stretched between two points attached to a frame, and the belt jogs up and around a motor-driven pulley on a stage.

In some embodiments, the positioning system may utilize a rack and pinion drive. In some embodiments, a stationary rack may be mounted to a frame, and a pinion gear is mounted to a motor on a moving stage with the pinion gear meshing with the rack. As the motor is driven, the stage advances as the pinion gear engages different portions of the rack.

In general, figures of merit of a desired positioning system may include one or more of: minimal backlash, low friction, stiffness, and potentially backdriveability. A positioning system utilizing a leadscrew typically has high stiffness, low backlash if an anti-backlash nut is used, moderate friction, and may not be backdriveable. A positioning system utilizing a ball screw may have high stiffness, zero to minimal backlash, low friction, and may be moderately backdriveable but introduces a significant feeling of viscous drag. A positioning system utilizing a belt drive may be low stiffness (although is quite variable depending on the cross-sectional size of the belt, the material inside the belt, the length of belt, etc.), zero to minimal backlash, low friction, and may be easily backdriveable. A positioning system utilizing a rack and pinion may have high stiffness, low to high backlash depending on the exact configuration, low friction, and may be easily backdriveable. For a selected positioning system, the control system and control algorithm may be adapted to provide the desired user experience.

In some embodiments, a control loop receives an input (e.g., an applied force, torque, etc.) and affects the position or speed of the stage (by driving the stage actuators). This may be contrasted with a haptic feedback system in which the user applies a position input and a counter-force is generated by the control system (e.g., spinning a handwheel and a counter-torque is applied on the handwheel to provide haptic feedback).

In some embodiments, the motion of the stage may be controlled to enable the performance of a task that is characteristic of a tool other than the tool attached to the stage. In some embodiments, if the device attached to the stage is a cutting spindle, the stage may be controlled to travel along straight lines (at given angles relative to an edge) to mimic the cuts made by a miter saw. In some embodiments, the angle of the cutting spindle axis may be adjusted relative to the plane of the workpiece to mimic beveled cuts of the workpiece made using a compound miter saw. In some embodiments, the stage may be controlled to travel to specific locations in the plane to allow a user to use a cutting spindle attached to the stage like a programmable drill press. In some embodiments, the pattern of locations for cutting or drilling may be imported from a digital design (e.g., SVG, CAD, CAM, or similar data).

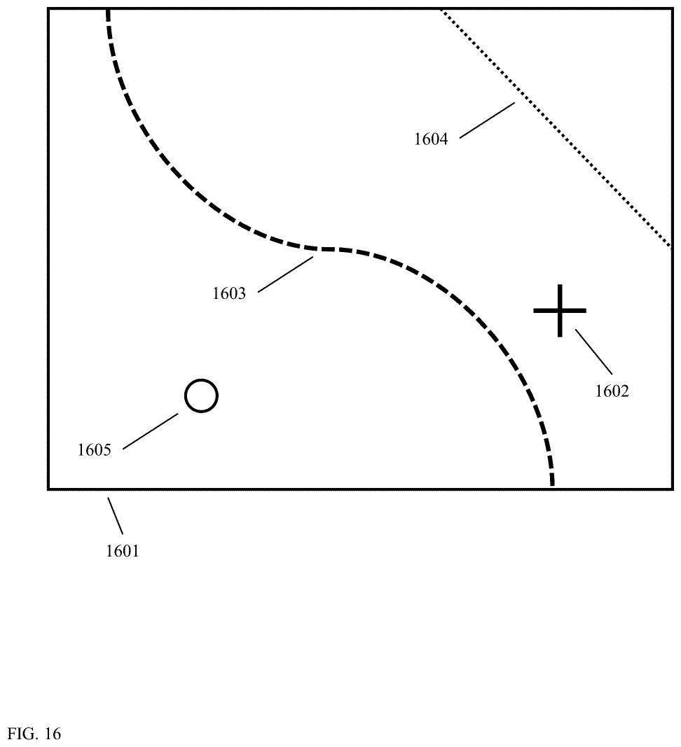

In some embodiments, a user may enter a path for the stage to follow (e.g., a path identifying a cut on a workpiece using the cutting bit mounted on a cutting spindle) based on information imported from a digital design. In some embodiments, the system may show the user the current position of the cutting bit relative to the path to be followed on a display. For example, as shown in FIG. 16, a portion of the display may show data 1601 including the path 1603 (dashed line) and the current position of the cutting bit represented by a “+” mark 1602. In some embodiments, displayed information 1601 may include features associated with position-based haptics (e.g., virtual grid lines, detents, attractors, and detractors). Features associated with different haptic types may use one or more of different color, marker, or line types, e.g., virtual grid line 1604 (dotted line), attractor 1605 (circle).

Once the user is ready to cut, the user can command the control system 4103 to align the cutting bit with the path (e.g., based on the nearest point on the path relative to the current position of the cutting bit) and begin cutting. Once the cutting is started, control system 4103 may follow the path 1603 based on inputs from the user on a sensor (e.g., force sensor 5110). If the inputs from the user would move the stage such that the cutting bit would leave the path, the control system 4103 may follow only the portion of the user input that is along (e.g., tangential to) the path to be followed (e.g., disregarding the portion of the user input that is perpendicular to the path). With this control process, the user's hand-forces impart control of the speed or position along the path, but the control system 4103 keeps the cutting bit on the path without tasking the user to follow the path exactly.

The above-described process allows a user to interactively control the cut, which means that they maintain the ability to stop the cut if something is wrong, or adjust the speed as needed. In some embodiments, to assist the user guide the stage along the path 1603, control system 4103 may output information 1601 on a display to show the path 1603 and current position of the cutting bit as a “+” mark 1602. In some embodiments, control system 4103 may update the position of the cutting bit 1602 as it moves along the path 1603 in the displayed information 1601. In some embodiments, control system 4103 may update the displayed portions of the path 1603 in the displayed information as portions of the path are cut—some portions of the cut path are removed from displayed information 1601, some new portions of the not-yet-cut path are added to displayed information 1601. Displayed information 1601 may be updated by the control system at 60 Hz or more to provide current information as the cut is made.

In some embodiments, a user may work on a set of points (e.g., for drilling holes on a workpiece) or a surface (e.g., for carving into the workpiece). The physical configuration of the positioning system, including the number of translational and rotational degrees of freedom implemented on the positioning system, may permit different tasks to be performed on points, paths, or surfaces. For example, if the positioning system includes roll or pitch rotational degrees of freedom, the positioning system may provide the capability to drill holes that are at an angle relative to a workpiece surface normal (e.g., drilling holes at an angle relative to the top surface of workpiece 109 using bit 106 in FIG. 1A). If the positioning system includes roll or pitch rotational degrees of freedom in addition to XYZ translational degrees of freedom, the positioning system may provide the capability to drill holes that are normal to a contoured surface on a workpiece. In this example, if the contoured surface of the workpiece is registered with the coordinate system of the positioning system (e.g., from a digital design, scanning the workpiece surface, etc.), the positioning system may control the stage to position the cutting bit such that it is normal to a given point on the contoured surface of the workpiece. In some embodiments, if the user's input to move to a point on the contoured surface would result in a cutting bit penetrating the contoured surface, the positioning system may only apply the components of the user's input that do not result in the cutting bit penetrating the contoured surface. This allows the user to control the motion of the cutting bit on the contoured surface without needing to worry about the cutting bit penetrating the contoured surface.

In some embodiments, a user may use the system to cut a workpiece without using a preconfigured path or design. In such instances, the control system 4103 may perform a “free” cut based on inputs from the user on a sensor (e.g., force sensor 5110), for example, to follow a path drawn on the workpiece. Normally this may be difficult to control with a traditional router because the cut forces can change rapidly due to changes in wood grain, knots, gaps, and direction of cut. However, with a sensor for receiving user input and a sensor to measure forces on a spindle, control system 4103 may sense the cutting forces rapidly and isolate them from the user input such that the stage does not jump uncontrollably when cutting forces change rapidly. In some embodiments, control system 4103 may track allowed range of motion to prevent the stage from entering exclusion areas (e.g., areas with support clamps, areas outside permitted workspace). In such instances, a user performing a “free” cut is prevented from damaging components accidentally. In some embodiments, control system 4103 may provide feedback to the user (e.g., via a haptic signal (e.g., changing tactile active force 7129, changing tactile passive force 7130) or changing the resistance of the stage motion (e.g., changing virtual stage mass 7135, changing virtual drag 7133)) if the user approaches an exclusion area (e.g., if the user is withing 100 mm, 50 mm, 20 mm, or 10 mm of an exclusion area).

In one embodiment, control algorithm 6123 may implement force feedback control by mapping a positive force input to a constant positive velocity and a negative force input to a constant negative velocity. Virtual friction may be implemented as a threshold force input to move the stage and may be subtracted from the force value used to determine the velocity. One possible visualization of friction may be a “flat” portion of the target velocity (y-axis) versus applied force (x-axis) response curve with the target velocity equaling zero until an applied force overcomes friction. In some embodiments, virtual friction may be implemented to prevent vibrations of the handle (which may lead to false sensed input due to inertia of the handle) from resulting in unintended motion of the stage. Similarly, if the positioning system is not flat (e.g., slightly tilted), the weight of the handle may be interpreted as a transverse force applied on the handle, which may lead to unintended motion of the stage in the absence of virtual friction. If a sensor measures force in the Z direction, the weight suspended by the sensor may be subtracted to detect magnitude of applied force.

In another embodiments, control algorithm 6123 may implement force feedback control by mapping an input force to map to a target velocity, e.g., linearly (as discussed above with respect to FIGS. 2, 3), cubically, scaling (e.g., monotonic apart from friction), etc., again, in some embodiments, with virtual friction incorporated as a threshold to move the stage (as described above). In some embodiments, such control loops permit combined benefits of fine and coarse stage motion control.

In another embodiment, control algorithm 6123 may implement force feedback control by mapping an input force to the output force of a drive motor, see, for example, FIG. 12, above. A goal of such a control loop may be to assist the user in overcoming the inherent friction and drag forces in the linear transmission elements, while otherwise directly causing the stage to accelerate or decelerate in accordance with the governing laws of physics.

For a given control algorithm 7123, parameters related to virtual friction or virtual drag (e.g., velocity-dependent drag, viscous drag) may be tuned based on expected user force input range and expected stage velocity range. In some embodiments, the parameters may depend on desired sensitivity of the stage motion (e.g., fine positioning, coarse positioning)—different parameters may be used if the user selects a different sensitivity of the stage motion. If the virtual drag is set too high, the control system may become frustrating and fatiguing for the user because it is perceived as an impediment to free motion of the stage. Some values of the virtual friction or virtual drag may not feel realistic to the user based on the expected motion of the stage given its size, travel range, and velocities in use.

The effect of simulated inertia on the tactile experience of manually positioning the stage is palpable to the user based on perceived response of the system. The virtual mass parameter may be adjusted in order to make the stage responsive and appear more realistic to the user. If the simulated inertia value is too high, the stage may be difficult to get started moving and equally difficult to stop. If the simulated inertia value is too low, drag may dominate and realism of the system response may be reduced. The value of the virtual mass may be scaled relative to real-world units of mass in order to perceptually feel correct within the overall context and scale of the system (e.g., geometry of the stage assembly, etc.) and the specific control loop implementation (e.g., based on scaling of applied and simulated forces).

In some embodiments, system parameters, such as magnitude of measured force, rate of change of measured force, current draw of the actuator motors, or in the case of stepper motors, the phase relationship between their mechanical and electrical positions, or the like, may be monitored to screen for events such as contact with a workpiece or interference with stage motion (e.g., user contacting the moving stage at a location other than where motion input is provided). Such monitoring may be used to stop or reverse the stage motion to prevent damage to the system or to avoid having the user experience an unexpected motion of the stage.

For example, should the spindle make contact with a workpiece, and in the absence of provisions in the control system, simulated inertia may cause the contact force to become quite large. This is because simulated inertia tends to carry the stage into the surface, just as if an object with real mass were to hit a surface with some speed. If the force sensor is located between the spindle and the machine structure, as contemplated in some embodiments, it is sensitive to the forces generated by these contact events, meaning that the control system can detect and take corrective action before the force level reaches an excessive level (and the control algorithm drives the stage motion based on the (large) contact forces), see FIGS. 13-15. These actions may include one or more of the following: ending the inertial simulation, stopping the stage, initiating motion in the opposite direction (e.g., using back-off algorithm 7140), turning off the spindle, retracting the spindle from the workpiece, sounding an audible alert, or displaying an alert notification.

In some embodiments, a cutting tool or probing bit is brought into contact with the workpiece in order to measure the position of the workpiece relative to the machine frame. This may be done on any surface of the workpiece, including the top surface or the side edge. Depending on the location of the sensor utilized for controlling the stage motion, a significant reaction force in the direction opposite the motion creating the contact may be included in the motion control loop. Several factors may contribute to the generation of the significant reaction force, including one or more of: a) lag time between when an initial contact force occurs and when the control system is able to react to it, b) the virtual inertia of the stage, which causes the stage to continue motion into the workpiece while it decelerates, even after a contact force is registered, and c) actual physical inertia of the stage which prevents it from stopping immediately on contact.

One solution to address this issue may include detecting a probing or touch-off “contact event” by recognizing force signals that are characteristic of such an event but do not occur during normal user operation. This recognition may occur during normal operation of the machine, or alternatively when the machine enters a “probing mode.” Examples that trigger a contact-related action may include one or more of: (1) detection of force input levels that exceed a threshold. For example, contact events may be registered as >10 N or 20 N of input force, while nominal user-generated forces tend to be less than 10 N, and (2) measurement of the slew rate of the contact force—for example, greater than 100 N/s, 200 N/s, 500 N/s, 1000 N/s, 2000 N/s, or more. These impulse measurements can be quite sensitive to contact events and allow the control system to react before high forces are generated. In some embodiments, scaling factor 6126 may be increased to increase contact sensitivity during probing.

Any of the above-described triggers may be combined with a configuration to detect contact via a two-sensor configuration as described earlier. One sensor measures only the user-applied force (e.g., sensor 160 in FIG. 1B, sensor 5110 in FIG. 5), while another sensor measures the total force on the spindle (e.g., sensor 154 in FIG. 1B, sensor 5104 in FIG. 5), which includes the user-applied force, see arrangement in FIGS. 1B, 5, 10, and 11. By taking the difference of these sensor readings, a contact force can be determined directly. In some embodiments, this may allow the control system to detect contact events at a much lower force level (limited by factors including the noise floor of the sensor system, and error in compensating for inertial forces as described earlier).

If a contact event is detected, using a method that may include one or more of those described above, the control system may implement one or more of: (1) disable the normal simulated physics control mode, (2) cease all motion in the direction of contact, or (3) enter a different contact control mode that backs off of contact. This subsequent contact mode may operate in the following ways: (1) moving at a constant velocity in the direction of the contact reaction force until the magnitude of the contact reaction force is below a certain threshold, (2) moving in the manner of a traditional PID control loop with the aim of bringing the contact force to zero, (3) with advance knowledge of the system stiffness, which may be pre-determined or obtained by instantaneously analyzing the force measurement data surrounding the contact event, the precise stage position of the contact event may be determined and moved to directly, or (4) moving at a velocity proportional to the contact force.

In some embodiments, a haptic grid may be implemented to provide feedback relating to position information to a user. In some embodiments, the haptic grid may include features related to a “wall” grid, in which the force required to move the stage increases dramatically when the stage is in a “haptic region” (e.g., a virtual grid point, virtual grid box, virtual grid circle, etc. —for example a haptic region located at increments of 5 mm in X and Y). This may require a high sampling rate in order to arrest the stage when it contacts a haptic region, rather than after it has already sailed past it. In some implementations, the current stage velocity or current stage position may be taken into account or a high-force threshold may be anticipated in advance. A haptic grid including features of a “wall” grid may also include features from other haptic elements.

In some embodiments, the haptic grid may include features related to a “magnetic” grid, in which the stage is attracted to a haptic region in a manner similar to a spring-loaded ball detent. As the stage approaches the haptic region within a certain tolerance, an attractive force reinforces motion towards that haptic region. Additional force is required to escape the magnetic well of the haptic region “detent.” A haptic grid including features of a magnetic grid may also include elements from other haptic elements, including the “wall” grid described above.

In some embodiments, the perception of the haptic grid may be tied to the virtual mass of the stage. Higher masses tend to inertially smooth out the effect of the haptic grid, and it may be desirable to change the behavior of the grid based on the value of the virtual mass, or to affect the value of the virtual mass when in proximity to the grid. Haptic approaches, including those grid types described above, may also be applied when in proximity to additional virtual elements including a cutting path based on a digital design as described above.

In some embodiments, input devices (e.g., input devices 5113) may be provided to configure the control system. For example, input from input devices may allow the user to set the configuration of the positioning system into a probing mode or contact mode. In some embodiments, input devices may move with the stage (e.g., input devices 5113) or may remain fixed (e.g., fixed to the work area edge).

FIG. 1800 illustrates an example of a computer system 1800 that may be used to execute program code stored in a non-transitory computer readable medium (e.g., memory) in accordance with embodiments of the disclosure. Control system (e.g., control system 4103, control system 6103) may be implemented on a computer system similar to computer system 1800. The computer system includes an input/output subsystem 1802, which may be used to interface with human users or other computer systems depending upon the application. The I/O subsystem 1802 may include, e.g., a keyboard, mouse, graphical user interface, touchscreen, or other interfaces for input, and, e.g., an LED or other flat screen display, or other interfaces for output, including application program interfaces (APIs). The I/O subsystem 1802 may include one or more components to receive output from a load cell amplifier or other sensor measurement system coupled to sensors for detecting the input from the user to control the positioning system. The one or more components may include data acquisition electronics to read the sensor output, load cell amplifier output, or the sensor measurement system output.

Program code may be stored in non-transitory computer-readable media such as persistent storage in secondary memory 1810 or main memory 1808 or both. Main memory 1808 may include volatile memory such as random access memory (RAM) or non-volatile memory such as read only memory (ROM), as well as different levels of cache memory for faster access to instructions and data. Secondary memory 1810 may include persistent storage such as solid state drives, hard disk drives or optical disks. One or more processors 1804 read program code from one or more non-transitory media and execute the code to enable the computer system to accomplish the methods performed by the embodiments herein. Those skilled in the art will understand that the processor(s) may ingest source code, and interpret or compile the source code into machine code that is understandable at the hardware gate level of the processor(s) 1804. The processor(s) 1804 may include dedicated processors such as microcontrollers running firmware. The processor(s) 1804 may include specialized processing units (e.g., GPUs, FPGAs, ASICs) for handling specialized or computationally intensive tasks.

The processor(s) 1804 may communicate with external networks via one or more communications interfaces 1807, such as a network interface card, WiFi transceiver, etc. One or more bus systems 1805 communicatively couple the I/O subsystem 1802, the processor(s) 1804, peripheral devices 1806, communications interfaces 1807, main memory 1808, and secondary memory 1810. Embodiments of the disclosure are not limited to this representative architecture. Alternative embodiments may employ different arrangements and types of components, e.g., separate buses for input-output components and memory subsystems, or different arrangement and types of computer systems (e.g., multiple computer systems together executing program code to perform the methods described in the embodiments herein). Elements of embodiments of the disclosure, such as one or more servers (e.g., in the cloud) communicating with an app, may be implemented with at least some of the components (e.g., processor 1804, main memory 1808, communication interfaces 1807) of a computer system like that of computer system 1800.

Those skilled in the art will understand that some or all of the elements of embodiments of the disclosure, and their accompanying operations, may be implemented wholly or partially by one or more computer systems including one or more processors and one or more memory systems like those of computer system 1800. Some elements and functionality may be implemented locally and others may be implemented in a distributed fashion over a network through different servers, e.g., in client-server fashion, for example.

Those skilled in the art will recognize that, in some embodiments, some of the operations described herein (e.g., acquiring a specimen from a participant) that do not involve data processing may be performed by human implementation, or through a combination of automated and manual means.

Although the disclosure may not expressly disclose that some embodiments or features described herein may be combined with other embodiments or features described herein, this disclosure should be read to describe any such combinations that would be practicable by one of ordinary skill in the art. Unless otherwise indicated herein, the term “include” shall mean “include, without limitation,” and the term “or” shall mean non-exclusive or in the manner of “and/or.”.

In the claims below, a claim reciting “any one of claims X-Y” shall refer to any one of claims from claim X and ending with claim Y (inclusive). For example, “The system of any one of claims 7-11” refers to the system of any one of claims 7, 8, 9, 10, and 11.

APPENDIX Exemplary Force Feedback Loop—Velocity-Control Pseudo-Code (e.g., for exemplary positioning system described in FIG. 2, 3)

// Parameter Notes:
//
// parameter_friction: A base level of virtual friction that always acts opposite to the direction
of motion of the stage. It has the effect of preventing stage drift due to taring (offset) errors as
well as sensor noise. Additionally, some level of friction may make the stage more controllable
by the user. For an exemplary one-dimensional stage embodiment (pictured below), typical
values may range from 0.05N to 5N, with an exemplary value of 0.2N. The friction value may be
high enough to prevent the stage from fluttering when the the user is not applying a load to the
force sensor, and may be low enough that motion is not overly difficult. Additional friction may
make it easier to perform fine positioning, but may make gross motion more fatiguing. It is
possible to implement a static friction (i.e. in effect when the stage is stationary) and an
independent dynamic friction that takes effect only when the stage is in motion. Additionally,
friction may be dynamically increased to permit fine positioning, and decreased if the system can
sense that the user intends to perform gross motion. Such an approach that causes the counter-
acting force to decrease with velocity may be the inverse of drag.
//
// parameter_drag: A virtual drag force that always acts opposite to the direction of motion of the
stage. This may have the effect of limiting the velocity of the stage to a reasonable value, adding
realism to its motion, and may make the stage more controllable by the user. For an exemplary
one-dimensional stage embodiment (see Figs. 2, 3), typical values may range from 0.002N/mm/s
to 0.04 N/mm/s, with an exemplary value of 0.03 N/mm/s. The drag parameter value may be set
high enough that the stage does not feel too reactive and that small input forces do not result in
disproportionately large displacements of the stage before coming to a stop. Additionally, the
drag may be high enough that the user cannot easily saturate the maximum electro-mechanically
limited velocity of the system. However, the drag parameter may be low enough that moving the
stage feels natural and does not require excessive or fatiguing levels of force to traverse large
distances. In some embodiments, the tuning of the drag may be dependent on the tuning of the
virtual mass.
//
// parameter_mass: A virtual stage mass that is acted upon by a total calculated force resulting in
an acceleration or deceleration of the stage. This total calculated force may include contributions
from the user-applied force, virutal friction, virtual drag, and any other active or passive forces
from sources including the grid. For an exemplary one-dimensional stage embodiment (pictured
below), typical values may range from 5g to 50g, with an exemplary value of 30g. Note that
these values may be scaled relative to real-world units based on the nature of the exemplary one-
dimensional stage embodiment and the specific control loop implementation. In some
embodiments, the value of the virtual mass may be high enough so as to feel realistic and to
provide a suitable storage mechanism for the energy invested by the user. In some embodiments,
the value of the virtual mass may not be so high as to feel difficult to get started or to slow down.
In some embodiments, the value of the virtual mass may depend on the tuning of the drag. In
some embodiments, the value of the virtual mass may be adjusted dynamically based on the state
of the system, including its velocity, in order to facilitate both gross motions and fine
positioning.
//
// Force Notes:
//
// grid_getPassiveForce(v, x, f): Each grid implementation may generate a passive force
component that acts in a direction opposite to the momentum of the stage.
// grid_getActiveForce(v, x, f): Each grid implementation may generate an active force
component that acts in a direction either with or opposite to the momentum of the stage.

| | |
|---|---|
| controlLoop( ){ | // this code is run on an interrupt-driven basis, e.g., at 500hz |

// STEP 1: Calculate the passive force on the virtual stage. These forces always oppose the
momentum of the stage.

| | |
|---|---|
| force_passive = | parameter_friction + |
| | magnitude(stage_velocity) * parameter_drag + |
| | grid_getPassiveForce(stage_velocity, stage_position, sensor_force) |

// STEP 2: Calculate the active forces on the virtual stage. These forces can oppose or reinforce
the momentum of the stage.

| | |
|---|---|
| force_active = | sensor netForce + |
| | grid_getActiveForce(stage_velocity, stage_position, sensor_force) |

// STEP 3: determine acceleration of the virtual stage
if(stage_velocity > 0){ //presently moving in positive direction

| | |
|---|---|
| force total = force_active - force_passive | //passive force acts in negative direction. |
| | //this is the residual force available to further |
| | //accelerate or decelerate the stage, after all |
| | //friction, drag, and grid forces have been |
| | //subtracted out. |
| acceleration = (force_total / parameter_mass) | // F = MA → A = F/M |
| velocity_delta = acceleration / loop_frequency | // ΔV = A * Δt |

```
  // STEP 3B: Apply velocity limits.
    //In this sub-step, we ensure that the stage does not accelerate to a velocity
    //such that drag forces become negative leading into the next time-step. If we
    //ignore inertial forces, the additional velocity that is supported by the residual
    // “force_total” is given simply by that residual force divided by the drag
    //coefficient.
```

| | |
|---|---|
| if(velocity_delta > 0){ | //the stage is accelerating. Drag is the limiting factor. |

```
    velocity_delta_max = force_total / parameter_drag
    velocity_delta_limited = min(velocity_delta, velocity_delta_max)
```

| | |
|---|---|
| }else if(velocity_delta < 0){ | // Decelerating. We limit the velocity delta to |
| | // whatever would completely decelerate the |
| | // stage to stage_velocity = 0 during this loop |
| | // period. Otherwise, passive forces could cause |
| | // an in increase in stage momentum. |

```
    velocity_delta_min = −stage_velocity
    velocity_delta_limited = max(velocity_delta, velocity_delta_min)
  }else{ //acceleration = 0
    velocity_delta_limited = 0;
  }
}
if(stage_velocity < 0){ //presently moving in the negative direction
```

| | |
|---|---|
| force_total = force_active + force_passive | //passive force acts in positive direction |
| acceleration = (force_total / parameter_mass) | // F = MA -> A = F/M |
| velocity_delta = acceleration / loop_frequency | // AV = A * At |

// STEP 3B: Apply velocity limits.

| | |
|---|---|
| if(velocity_delta > 0){ | //the stage is accelerating. Drag is the limiting factor. |

```
    velocity_delta_max = force_total / parameter_drag
    velocity_delta_limited = min(velocity_delta, velocity_delta_max)
```

| | |
|---|---|
| }else if(velocity_delta < 0){ | // Decelerating. We limit the velocity delta to |
| | // whatever would completely decelerate the |
| | // stage to stage_velocity = 0 during this loop |
| | // period. Otherwise, passive forces could cause |
| | // an in increase in stage momentum. |

```
    velocity_delta_min = - stage_velocity
    velocity_delta_limited = max(velocity_delta, velocity_delta_min)
  }else{ //acceleration = 0
    velocity_delta_limited = 0;
  }
}
```

| | |
|---|---|
| if(stage_velocity == 0){ | //presently stationary. Passive forces cannot exceed active forces. |

```
  if(force_active > force_passive){
    force total = force_active - force_passive
  }else if(force_active < - force_passive){
    force total = force_active + force_passive
  }else{
    force_total = 0; //this catches the case where friction > applied force
  }
```

| | |
|---|---|
| acceleration = (force_total / parameter_mass) | // F = MA → A = F/M |
| velocity_delta = acceleration / loop_frequency | // ΔV = A * Δt |

// STEP 3B: Apply velocity limits.

| | |
|---|---|
| if(velocity_delta < 0){ | //the stage is accelerating. Drag is the limiting factor. |

```
    velocity_delta_max = force_total / parameter_drag
    velocity_delta_limited - max(velocity_delta, velocity_delta_max)
```

| | |
|---|---|
| }else if(velocity_delta > 0){ | // Decelerating. We limit the velocity delta to |
| | // whatever would completely decelerate the |
| | // stage to stage_velocity = 0 during this loop |
| | // period. Otherwise, passive forces could cause |
| | // an in increase in stage momentum. |

```
    velocity_delta_min = −stage_velocity
    velocity_delta_limited = max(velocity_delta, velocity_delta_min)
  }else{ //acceleration = 0
    velocity_delta_limited = 0;
  }
}
// STEP 4: Set new stage velocity
stage_velocity += velocity_delta_limited
} //End the control loop
NOTE:
“stage_velocity” is a variable that causes an independent element of the control system (e.g. an interrupt-driven step-generation routine, or a hardware timer) to directly affect the rate of motion of the stage.
```

### Contact Events

The above code may also include provisions to handle contact events, as described earlier. These events may cause the control loop to enter an alternative mode that entirely bypasses the typical physics simulation, or may also cause a switch from velocity control of the motor to position control, in order to implement specific back-off routines as described earlier. In the above pseudo-code, the final step of the control loop is to set the stage velocity, which affects the rate of motion of the stage via another independent element of the control system. In some embodiments, if a contact event has been triggered, the control loop may set a “stage_position” parameter instead of or in addition to the stage velocity. This parameter may similarly affect an independent element of the control system to bring the stage to a specific position.

```
// Parameter Notes
//
// parameter_backoffForceThreshold: Automatic back-off after a contact
event will end once the contact force drops below this threshold. A
typical value may be 0.1N.
//
// parameter_backoffVelocity: The speed at which the stage backs off
automatically after a contact event. A typical value may be 1mm/s
//
// parameter_backoffVelocityCoefficient: A constant that relates the
back-off speed of the stage after a contact event to the instantaneous
contact force. A typical value may be 1mm/s/N.
//
// parameter_contactStiffness: this is the estimated stiffness of the system
during the contact event. It may be predetermined, or evaluated based on
recent measurements at the time that the contact event has been triggered.
A typical value may be 100 N/mm.
controlLoop_Probe( ){
if(contactEvent (sensor_netForce, sensor_impulse, motorDriveCurrent){
  if(magnitude(sensor_netForce > parameter_backoffForceThreshold)){
    // back off in the direction of the contact force.
    // CONSTANT BACKOFF SPEED
    stage_velocity = sign(sensor_netForce) *
    parameter_backoffVelocity
    // -- OR --
    // PROPORTIONAL BACKOFF SPEED
    stage_velocity = sensor_netForce *
    parameter_backoffVelocityCoefficient
    // -- OR --
    // POSITION-DRIVEN BACKOFF
    stage_position += sensor_netForce / parameter_contactStiffness
  }else{
    endContactEvent( )
    stage_velocity = 0;
  }
}else{
  Step 1
  Step 2
  Step 3
  Step 4
}
```

The pseudo-code provided above may be stored on one or more memories and the pseudo-code may be executed by one or more processors of a computer system. Methods described herein and operations executed by systems described herein may be embodied in non-transitory computer readable media storing instructions that, when executed by one or more processors, perform the described methods or execute the described operations.

### Embodiments

Each embodiment set (A, B, . . . ) below includes dependent embodiments that are dependent on embodiments within the same embodiment set.

### Embodiment Set A

1. A system for controlling motion of a stage based on input from a user, the system comprising: one or more actuators coupled to the stage, wherein at least one actuator of the one or more actuators is operable to move the stage with respect to at least one degree of freedom; one or more processors;
a first sensor operably coupled to at least one of the one or more processors, wherein the first sensor is coupled to the stage;
one or more memories each operably coupled to a respective at least one of the one or more processors, wherein at least one of the one or more memories comprise instructions that, when executed by at least one of the one or more processors, cause the system to:
receive first information based at least in part upon a first signal from the first sensor, wherein the first information is based at least in part upon a first input from the user, the first information corresponds to a first value associated with the first input, and the stage is at a first stage location when the first information is received; and
provide second information that causes a first actuator of the one or more actuators to move the stage, wherein the second information is based at least in part upon the first information, the stage moves in a stage travel direction in response to the provided second information, and the first sensor moves with the stage in the stage travel direction in response to the provided second information.

2. The system of embodiment 1, wherein the instructions, when executed by at least one of the one or more processors, cause the system to:
receive third information based at least in part upon a second signal from the first sensor, wherein the third information is based at least in part upon a second input from the user, the third information corresponds to a second value associated with the second input, the stage is at a second stage location when the third information is received, and the second stage location is different from the first stage location; and
provide fourth information that causes the first actuator to move the stage, wherein the fourth information is based at least in part upon the third information.

3. The system of embodiment 2, wherein the first value corresponds to a first magnitude, the second value corresponds to a second magnitude, the second magnitude is less than the first magnitude, the second information corresponds to a third magnitude, the fourth information corresponds to a fourth magnitude, and the fourth magnitude is less than the third magnitude.

4. The system of embodiment 3, wherein the second information relates to a first stage velocity, the fourth information relates to a second stage velocity, and the second stage velocity is less than the first stage velocity.

5. The system of embodiment 2, wherein the first value corresponds to a first magnitude, the second value corresponds to a second magnitude, the second magnitude is less than the first magnitude, the second information relates to a first target stage position, providing the second information causes a first stage displacement, the fourth information relates to a second target stage position, providing the fourth information causes a second stage displacement, and the second stage displacement is less than the first stage displacement.

6. The system of any one of embodiments 2-5, wherein first sensor moves less than 5 mm, 2 mm, 1 mm, 0.1 mm, 0.05 mm, 0.02 mm, or 0.01 mm relative to the stage in response to the first input.

7. The system of embodiment 6, wherein the first sensor moves less than 5 mm, 2 mm, 1 mm, 0.1 mm, 0.05 mm, 0.02 mm, or 0.01 mm relative to the stage in response to the second input.

8. The system of any one of embodiments 2-7, wherein the third information is received less than 1000 ms, 500 ms, 200 ms, 100 ms, 50 ms, 20 ms, 10 ms, 5 ms, or 2 ms after the first information is received.

9. The system of embodiment 8, wherein new third information is received repeatedly, wherein new third information is received within every 1000 ms, 500 ms, 200 ms, 100 ms, 50 ms, 20 ms, 10 ms, 5 ms, or 2 ms, and new fourth information is provided based on every newly received third information.

10. The system of any one of embodiments 1-9, wherein the first input corresponds to a first direction in a plane, and the provided second information causes the stage to move in the stage travel direction which, projected to the plane, points in the same direction as the first direction to within less than 10 deg, 5 deg, 2 deg, 1 deg, 0.5 deg, 0.2 deg, or 0.1 deg.

11. The method of embodiment 10, wherein the second input corresponds to a second direction in the plane, the provided fourth information causes the stage to move in a third direction in the plane, the third direction points in the same direction as the second direction to within less than 10 deg, 5 deg, 2 deg, 1 deg, 0.5 deg, 0.2 deg, or 0.1 deg, and the second direction points in the opposite direction as the first direction to within less than 10 deg, 5 deg, 2 deg, 1 deg, 0.5 deg, 0.2 deg, or 0.1 deg.

12. The method of embodiment 11, wherein the angle between the first direction and the second direction is about 180 degrees, the first input corresponds to a push or pull action by the user, and the second input corresponds to a pull or push action by the user, respectively.

13. The system of any one of embodiments 1-12, wherein the first value relates to a force, and the first sensor is a force sensor.

14. The system of any one of embodiments 1-12, wherein the first value relates to a contact area, and the first sensor is a touch sensor.

15. The system of any one of embodiments 1-12, wherein the first value relates to a deflection of an element of the first sensor.

16. The system of embodiment 15, wherein a joystick controller comprises a deflection sensor and a stick, the first sensor is the deflection sensor, and the element is the stick.

17. The system of any one of embodiments 1-16, wherein the second information is based at least in part upon a virtual mass of the stage.

18. The system of any one of embodiments 1-17, wherein the second information is based at least in part upon a virtual drag force acting on the stage.

19. The system of any one of embodiments 1-18, wherein the second information is based at least in part upon a virtual friction force acting on the stage.

20. The system of any one of embodiments 1-19, wherein the second information is based at least in part upon a virtual position-dependent force acting on the stage.

21. The system of any one of embodiments 1-20, wherein the second information is based at least in part upon a virtual velocity-dependent force acting on the stage.

22. The system of any one of embodiments 17-21, wherein the user provides a parameter input associated with one or more of: the virtual mass, the virtual drag, the virtual friction force, the virtual position-dependent force, or the virtual velocity-dependent force, and the parameter input adjusts the stage motion sensitivity to the first input.

23. The system of any one of embodiments 1-22, wherein the at least one actuator of the one or more actuators is operable to translate the stage in at least one dimension.

24. The system of embodiment 23, wherein the at least one actuator of the one or more actuators is operable to translate the stage by more than 5 cm, 10 cm, 20 cm, 50 cm, or 100 cm in the at least one dimension.

25. The system of any one of embodiments 1-24, wherein the at least one actuator of the one or more actuators is operable to rotate the stage along at least one axis of rotation.

26. The system of any one of embodiments 1-25, wherein the first information is based at least in part upon a contact between a component coupled to the stage and a workpiece.

27. The system of embodiment 26, wherein the component coupled to the stage comprises a spindle, and the spindle is configured to receive and attach a cutting bit or probing bit.

28. The system of embodiment 26, wherein the component coupled to the stage comprises a probing head.

29. The system of any one of embodiments 1-25, wherein the system further comprises: a device coupled to the stage;
a second sensor operably coupled to at least one of the one or more processors, wherein the second sensor is coupled to the device and the stage, and the second sensor is different from the first sensor; and
wherein the instructions, when executed by at least one of the one or more processors, cause the system to:
receive fifth information based at least in part upon a third signal from the second sensor, wherein the fifth information is based at least in part upon contact between the device and a workpiece, the fifth information corresponds to a third value associated with the contact, and the stage is at a third stage location when the fifth information is received; and
provide sixth information that causes the first actuator of the one or more actuators to move the stage, wherein the sixth information is based at least in part upon the fifth information, and the second sensor moves with the stage in response to the provided sixth information.

30. The system of embodiment 29, wherein the device comprises a spindle, and the spindle is configured to receive and attach a cutting bit or probing bit.

31. The system of embodiment 29, wherein the device comprises a probing head.

32. A method for controlling motion of a stage based on input from a user, the method comprising:
receiving first information based at least in part upon a first signal from a first sensor, wherein the first sensor is coupled to the stage, one or more actuators are coupled to the stage, at least one actuator of the one or more actuators is operable to move the stage with respect to at least one degree of freedom, the first information is based at least in part upon a first input from the user, the first information corresponds to a first value associated with the first input, and the stage is at a first stage location when the first information is received; and
providing second information that causes a first actuator of the one or more actuators to move the stage, wherein the second information is based at least in part upon the first information, the stage moves in a stage travel direction in response to the provided second information, and the first sensor moves with the stage in the stage travel direction in response to the provided second information.

33. One or more non-transitory computer-readable media storing instructions for controlling motion of a stage based on input from a user, wherein the instructions, when executed by one or more computing devices, cause at least one of the one or more computing devices to:
receive first information based at least in part upon a first signal from a first sensor, wherein the first sensor is coupled to the stage, one or more actuators are coupled to the stage, at least one actuator of the one or more actuators is operable to move the stage with respect to at least one degree of freedom, the first information is based at least in part upon a first input from the user, the first information corresponds to a first value associated with the first input, and the stage is at a first stage location when the first information is received; and
provide second information that causes a first actuator of the one or more actuators to move the stage, wherein the second information is based at least in part upon the first information, the stage moves in a stage travel direction in response to the provided second information, and the first sensor moves with the stage in the stage travel direction in response to the provided second information.

### Embodiment Set B

1. A system for controlling motion of a stage based on input from a user, the system comprising: one or more actuators coupled to the stage, wherein at least one actuator of the one or more actuators is operable to move the stage with respect to at least one degree of freedom; one or more processors;
a first sensor operably coupled to at least one of the one or more processors, wherein the first sensor is coupled to the stage, and the first sensor is coupled to an input surface;
one or more memories each operably coupled to a respective at least one of the one or more processors, wherein at least one of the one or more memories comprise instructions that, when executed by at least one of the one or more processors, cause the system to:
receive first information based at least in part upon a first signal from the first sensor, wherein the first information is based at least in part upon a first push action executed by the user on the input surface, the first information corresponds to a first value associated with the first push action, and the stage is at a first stage location when the first information is received; and
provide second information that causes a first actuator of the one or more actuators to move the stage, wherein the second information is based at least in part upon the first information, the stage moves in a stage travel direction in response to the provided second information, and the first sensor moves with the stage in the stage travel direction in response to the provided second information.

2. The system of embodiment 1, wherein the instructions, when executed by at least one of the one or more processors, cause the system to:
receive third information based at least in part upon a second signal from the first sensor, wherein the third information is based at least in part upon a second push action executed by the user on the input surface, the third information corresponds to a second value associated with the second push action, the second value is less than the first value, the stage is at a second stage location when the third information is received, and the second stage location is different from the first stage location; and
provide fourth information that causes the first actuator to move the stage, wherein the fourth information is based at least in part upon the third information, and the fourth information reduces the speed of the stage.

3. The system of embodiment 2, wherein the instructions, when executed by at least one of the one or more processors, cause the system to:
receive fifth information based at least in part upon a third signal from the first sensor, wherein the fifth information is based at least in part upon a first pull action executed by the user on the input surface, the fifth information corresponds to a third value associated with the first pull action, the stage is at a third stage location when the fifth information is received, and the third stage location is different from the first and the second stage location; and
provide sixth information that causes the first actuator to move the stage, wherein the sixth information is based at least in part upon the fifth information, and the sixth information causes the stage to travel in a direction opposite the stage travel direction to within less than 10 deg, 5 deg, 2 deg, 1 deg, 0.5 deg, 0.2 deg, or 0.1 deg.

4. The system of embodiment 3, wherein the input surface corresponds to a portion of a surface of a handle coupled to the stage.

5. The system of embodiment 3 or 4, wherein a direction of a component of force associated with the first pull action is opposite to a direction of a component of force associated with the first push action to within less than 10 deg, 5 deg, 2 deg, 1 deg, 0.5 deg, 0.2 deg, or 0.1 deg.

6. The system of any one of embodiments 3-5, wherein the first sensor is a force sensor.

7. The system of any one of embodiments 3-6, wherein the first stage travel direction is in the same direction as the first push action to within less than 10 deg, 5 deg, 2 deg, 1 deg, 0.5 deg, 0.2 deg, or 0.1 deg.

8. A method for controlling motion of a stage based on input from a user, the method comprising:
receiving first information based at least in part upon a first signal from a first sensor, wherein the first sensor is coupled to the stage, the first sensor is coupled to an input surface, one or more actuators are coupled to the stage, at least one actuator of the one or more actuators is operable to move the stage with respect to at least one degree of freedom, the first information is based at least in part upon a first push action executed by the user on the input surface, the first information corresponds to a first value associated with the first push action, and the stage is at a first stage location when the first information is received; and
providing second information that causes a first actuator of the one or more actuators to move the stage, wherein the second information is based at least in part upon the first information, the stage moves in a stage travel direction in response to the provided second information, and the first sensor moves with the stage in the stage travel direction in response to the provided second information.

9. One or more non-transitory computer-readable media storing instructions for controlling motion of a stage based on input from a user, wherein the instructions, when executed by one or more computing devices, cause at least one of the one or more computing devices to:
receive first information based at least in part upon a first signal from a first sensor, wherein the first sensor is coupled to the stage, the first sensor is coupled to an input surface, one or more actuators are coupled to the stage, at least one actuator of the one or more actuators is operable to move the stage with respect to at least one degree of freedom, the first information is based at least in part upon a first push action executed by the user on the input surface, the first information corresponds to a first value associated with the first push action, and the stage is at a first stage location when the first information is received; and
provide second information that causes a first actuator of the one or more actuators to move the stage, wherein the second information is based at least in part upon the first information, the stage moves in a stage travel direction in response to the provided second information, and the first sensor moves with the stage in the stage travel direction in response to the provided second information.

1. A system for controlling motion of a stage based on input from a user, the system comprising:
one or more actuators coupled to the stage, wherein at least one actuator of the one or more actuators is operable to move the stage with respect to at least one degree of freedom;
one or more processors;
a first sensor operably coupled to at least one of the one or more processors, wherein the first sensor is coupled to the stage;
one or more memories each operably coupled to a respective at least one of the one or more processors, wherein at least one of the one or more memories comprise instructions that, when executed by at least one of the one or more processors, cause the system to:
receive first information based at least in part upon a first signal from the first sensor, wherein the first information is based at least in part upon a first input from the user, the first information corresponds to a first value associated with the first input, and the stage is at a first stage location when the first information is received; and
provide second information that causes a first actuator of the one or more actuators to move the stage, wherein the second information is based at least in part upon the first information, the stage moves in a stage travel direction in response to the provided second information, and the first sensor moves with the stage in the stage travel direction in response to the provided second information.

2. The system of claim 1, wherein the instructions, when executed by at least one of the one or more processors, cause the system to:
receive third information based at least in part upon a second signal from the first sensor,
wherein the third information is based at least in part upon a second input from the user, the third information corresponds to a second value associated with the second input, the stage is at a second stage location when the third information is received, and the second stage location is different from the first stage location; and
provide fourth information that causes the first actuator to move the stage, wherein the fourth information is based at least in part upon the third information.

3. The system of claim 2, wherein the first value corresponds to a first magnitude, the second value corresponds to a second magnitude, the second magnitude is less than the first magnitude,
the second information relates to a first stage velocity, the fourth information relates to a second stage velocity, and the second stage velocity is less than the first stage velocity.

4. The system of claim 2, wherein the first value corresponds to a first magnitude, the second value corresponds to a second magnitude, the second magnitude is less than the first magnitude,
the second information relates to a first target stage position, providing the second information causes a first stage displacement, the fourth information relates to a second target stage position, providing the fourth information causes a second stage displacement, and the second stage displacement is less than the first stage displacement.

5. The system of claim 2, wherein first sensor moves less than 5 mm, 2 mm, 1 mm, 0.1 mm, 0.05 mm, 0.02 mm, or 0.01 mm relative to the stage in response to the first input, and the first sensor moves less than 5 mm, 2 mm, 1 mm, 0.1 mm, 0.05 mm, 0.02 mm, or 0.01 mm relative to the stage in response to the second input.

6. The system of claim 2, wherein the third information is received less than 1000 ms, 500 ms, 200 ms, 100 ms, 50 ms, 20 ms, 10 ms, 5 ms, or 2 ms after the first information is received.

7. The system of claim 6, wherein new third information is received repeatedly, wherein new third information is received within every 1000 ms, 500 ms, 200 ms, 100 ms, 50 ms, 20 ms, 10 ms, 5 ms, or 2 ms, and new fourth information is provided based on every newly received third information.

8. The system of claim 2, wherein the first input corresponds to a first direction in a plane, the provided second information causes the stage to move in the stage travel direction which, projected to the plane, points in the same direction as the first direction to within less than 10 deg, 5 deg, 2 deg, 1 deg, 0.5 deg, 0.2 deg, or 0.1 deg, the second input corresponds to a second direction in the plane, the provided fourth information causes the stage to move in a third direction in the plane, the third direction points in the same direction as the second direction to within less than 10 deg, 5 deg, 2 deg, 1 deg, 0.5 deg, 0.2 deg, or 0.1 deg, the second direction points in the opposite direction as the first direction to within less than 10 deg, 5 deg, 2 deg, 1 deg, 0.5 deg, 0.2 deg, or 0.1 deg such that an angle between the first direction and the second direction is about 180 degrees, the first input corresponds to a push or pull action by the user, and the second input corresponds to a pull or push action by the user, respectively.

9. The system of claim 8, wherein the first value relates to a force, and the first sensor is a force sensor.

10. The system of claim 1, wherein the at least one actuator of the one or more actuators is operable to translate the stage by more than 5 cm, 10 cm, 20 cm, 50 cm, or 100 cm in at least one dimension.

11. The system of claim 1, wherein the first information is based at least in part upon a contact between a component coupled to the stage and a workpiece.

12. The system of claim 11, wherein the component coupled to the stage comprises a spindle, and the spindle is configured to receive and attach a cutting bit or probing bit.

13. The system of claim 1, wherein the system further comprises:
a device coupled to the stage;
a second sensor operably coupled to at least one of the one or more processors, wherein the second sensor is coupled to the device and the stage, and the second sensor is different from the first sensor; and
wherein the instructions, when executed by at least one of the one or more processors, cause the system to:
receive fifth information based at least in part upon a third signal the second sensor, wherein the fifth information is based at least in part upon contact between the device and a workpiece, the fifth information corresponds to a third value associated with the contact, and the stage is at a third stage location when the fifth information is received; and
provide sixth information that causes the first actuator of the one or more actuators to move the stage, wherein the sixth information is based at least in part upon the fifth information, and the second sensor moves with the stage in response to the provided sixth information.

14. The system of claim 13, wherein the device comprises a spindle, and the spindle is configured to receive and attach a cutting bit or probing bit.

15. A system for controlling motion of a stage based on input from a user, the system comprising:
one or more actuators coupled to the stage, wherein at least one actuator of the one or more actuators is operable to move the stage with respect to at least one degree of freedom;
one or more processors;
a first sensor operably coupled to at least one of the one or more processors, wherein the first sensor is coupled to the stage, and the sensor is coupled to an input surface;
one or more memories each operably coupled to a respective at least one of the one or more processors, wherein at least one of the one or more memories comprise instructions that, when executed by at least one of the one or more processors, cause the system to:
receive first information based at least in part upon a first signal from the first sensor, wherein the first information is based at least in part upon a first push action executed by the user on the input surface, the first information corresponds to a first value associated with the first push action, and the stage is at a first stage location when the first information is received; and
provide second information that causes a first actuator of the one or more actuators to move the stage, wherein the second information is based at least in part upon the first information, the stage moves in a stage travel direction in response to the provided second information, and the first sensor moves with the stage in the stage travel direction in response to the provided second information.

16. The system of claim 15, wherein the instructions, when executed by at least one of the one or more processors, cause the system to:
receive third information based at least in part upon a second signal from the first sensor,
wherein the third information is based at least in part upon a second push action executed by the user on the input surface, the third information corresponds to a second value associated with the second push action, the second value is less than the first value, the stage is at a second stage location when the third information is received, and the second stage location is different from the first stage location; and
provide fourth information that causes the first actuator to move the stage, wherein the fourth information is based at least in part upon the third information, and the fourth information reduces the speed of the stage.

17. The system of claim 16, wherein the instructions, when executed by at least one of the one or more processors, cause the system to:
receive fifth information based at least in part upon a third signal from the first sensor, wherein the fifth information is based at least in part upon a first pull action executed by the user on the input surface, the fifth information corresponds to a third value associated with the first pull action, the stage is at a third stage location when the fifth information is received, and the third stage location is different from the first and the second stage location; and
provide sixth information that causes the first actuator to move the stage, wherein the sixth information is based at least in part upon the fifth information, and the sixth information causes the stage to travel in a direction opposite the stage travel direction to within less than 10 deg, 5 deg, 2 deg, 1 deg, 0.5 deg, 0.2 deg, or 0.1 deg.

18. The system of claim 17, wherein the input surface corresponds to a portion of a surface of a handle coupled to the stage.

19. The system of claim 17, wherein a direction of a component of force associated with the first pull action is opposite to a direction of a component of force associated with the first push action to within less than 10 deg, 5 deg, 2 deg, 1 deg, 0.5 deg, 0.2 deg, or 0.1 deg.

20. The system of claim 17, wherein the first stage travel direction is in the same direction as the first push action to within less than 10 deg, 5 deg, 2 deg, 1 deg, 0.5 deg, 0.2 deg, or 0.1 deg.
